(19) United States
(12) Patent Application Publication
(10) Pub. No.: US 2006/0241097 A1
(43) Pub. Date: Oct. 26, 2006

(54) Pesticidal substituted 1,2,5-thiadiazole derivatives

(75) Inventors: Leo B. Dungan, Lumberton, NJ (US); Elizabeth G. Rowley, Kendall Park, NJ (US); John A. Dixson, Newton, PA (US); Syed F. Ali, Yardville, NJ (US); Scott D. Crawford, Jackson, NJ (US); Saroj Sehgel, Junction, NJ (US); Matthew P. Whiteside, Morrisville, PA (US); Thomas M. Zydowsky, Brooklyn, NY (US); Walter H. Yeager, Yardley, PA (US)

Correspondence Address: Fmc Corporation;Patent Administrator, 1735 Market Street, Philadelphia, PA, 19103, US

(73) Assignee: FMC CORPORATION, Philadelphia, PA (US)

(21) Appl. No.: 10/563,643

(22) PCT Filed: Jul. 1, 2004
(86) PCT No.: PCT/US04/21313

§ 371 Date: Jun. 8, 2006

Related U.S. Application Data
(60) Provisional application No. 60/485,297, filed on Jul. 7, 2003.

(51) Int. Cl. A01N 43/62; A01N 43/42; A01N 43/00; A01N 43/90; A01N 43/40

(52) U.S. Cl. 514/214.01; 514/218; 514/235.2; 514/304; 514/305; 514/340; 514/341

(57) ABSTRACT

Insecticidal and acaricidal compositions comprising an insecticidally or acaricidally effective amount of a 1,2,5-thiadiazole of the formula (I); wherein R, Q and m are as defined in admixture with at least one agriculturally acceptable extender or adjuvant are disclosed. In addition, methods of controlling insects and acarids comprising applying said compositions to a locus of crops where control is desired are disclosed.

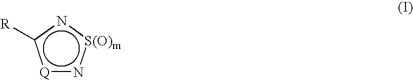

This application claims the benefit of U.S. Provisional Application No. 60/485,297, filed Jul. 7, 2003.

### FIELD OF THE INVENTION

The present invention relates to methods for controlling pests. In particular, it relates to control by the application of certain novel compositions containing pesticidal substituted 1,2,5-thiadiazole derivatives.

### BACKGROUND OF THE INVENTION

It is well known that pests such as insects and acarids can cause significant damage, not only to crops grown in agriculture, but also, for example, to structures and turf where the damage is caused by soil-borne insects, such as termites and white grubs. Such damage may result in the loss of millions of dollars of value associated with a given crop, turf or structure. Insecticides and acaricides are useful for controlling insects and acarids which may otherwise cause significant damage to crops such as wheat, corn, soybeans, potatoes, and cotton to name a few. For crop protection, insecticides and acaricides are desired which can control the insects and acarids without damaging the crops, and which have no deleterious effects to mammals and other living organisms. Surprisingly, it has now been found that compositions of substituted 1,2,5-thiadiazole derivatives of the present invention are unexpectedly active in controlling acarids, for example two-spotted spider mites; and also in controlling insects such as cotton aphids and termites, as well as other insect species.

Pharmacologically active 1,2,4-, 1,3,4-, and 1,2,5-oxadiazoles and 1,2,4-, 1,3,4- and 1,2,5-thiadiazoles have been reported in the literature, for example, Wätjen et al., U.S. Pat. No. 4,870,073; Baker et al., U.S. Pat. Nos. 4,952,587 and 5,686,463 and European Patent EP 0323864 A2; Sauerberg et al., U.S. Pat. Nos. 5,260,314, 5,481,240 and 5,527,813; Sauerberg et al., Journal of Medicinal Chem., Vol. 35, No. 12, pp. 2274-2283 (1992); Olesen et al., Eur. J. Med. Chem., 31, pp. 221-230 (1996); and MacLeod et al., Journal of Medicinal Chem., Vol. 33, pp. 2052-2059 (1990). Similarly, insecticidally and acaricidally active 1,2,4-, 1,3,4-, and 1,2,5-oxadiazoles, 1,2,3-, 1,2,4- and 1,3,4-thiadiazoles, 1,2,4-triazoles, and 1,2,3,4-tetrazoles have been reported in the literature. For example, Dick, U.S. Pat. No. 5,393,767; Tsubata et al., U.S. Pat. Nos. 6,337,341 B1 and 6,348,460 B1; Theobald et al., U.S. Pat. No. 4,943,584; and Matsumoto et al., U.S. Pat. No. 4,722,934. EP 0445731 A1 and WO 01/15532 disclose azabicyclo and azacyclo oxime and amine compounds as pesticides. It has also been disclosed that pharmacologically active 1,2,4- and 1,2,5-thiadiazoles and insecticidally and acaricidally active 1,2,4-oxdiazoles, 1,3,4-triazoles, and 1,2,3,4-tetrazoles can act as muscarinic agonists, see, for example, Sauerberg et al., Journal of Medicinal Chem., Vol. 35, No. 12, pp. 2274-2283 (1992); Dick et al., Pestic. Sci., 49, 268-276 (1997); Olesen et al., Eur. J. Med. Chem., 31, pp. 221-230 (1996); and MacLeod et al., Journal of Medicinal Chem., Vol. 33, pp. 2052-2059 (1990).

WO 95/03306 discloses arthropodically active substituted 1,2,5-oxadiazoles and 1,2,5-thiadiazoles; however, it specifically requires that the 1,2,5-oxadiazole or 1,2,5-thiadiazole be substituted with an azabicyclic compound rather than a tetrahydropyridyl or a pyridyl ring and that said azabicyclic compound can only attach at the two position when the bridge occurs between the nitrogen and a carbon atom on the ring.

WO 93/14636 and its equivalent U.S. Pat. No. 5,244,906 disclose certain substituted 1,2,4-oxadiazoles and 1,2,4-thiadiazoles useful for control of insects, such as sucking insects like two-spotted spider mite.

### SUMMARY OF THE INVENTION

It has now been found that certain compositions containing an effective amount of a 1,2,5-thiadiazole derivative, and their agriculturally acceptable salts, in admixture with at least one agriculturally acceptable extender or adjuvant are surprisingly effective in controlling sucking pests, i.e., acaricides, as well as insects. The 1,2,5-thiadiazole derivatives may be represented by the following formula I: 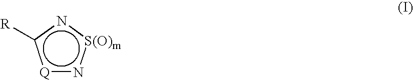
where
—R is an azacycle selected from: 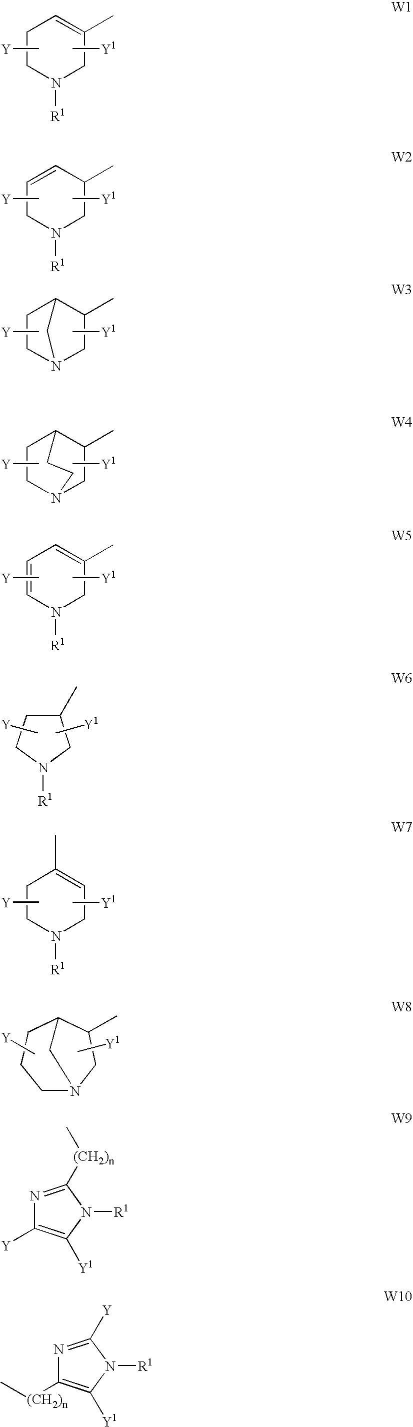 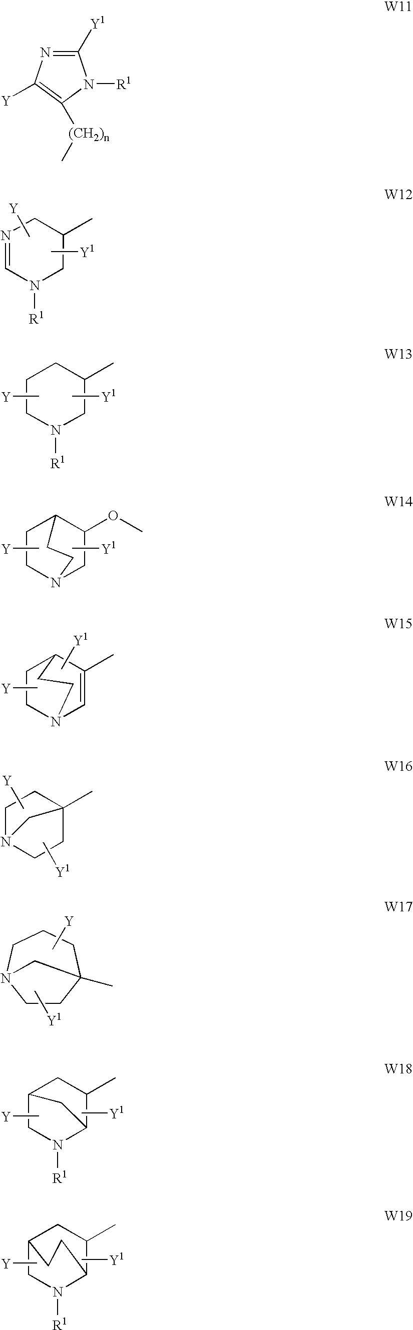 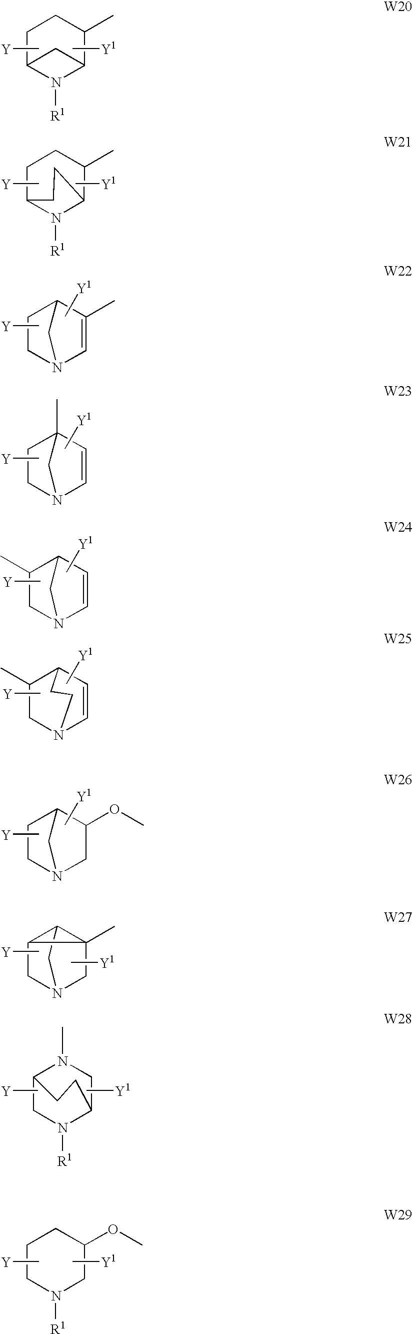
where
—Y and Y′ may be attached at the same or different positions, and are independently selected from hydrogen, halogen, cyano, nitro, amino, carboxyl, alkyl, haloalkyl, alkenyl, alkoxy, haloalkoxy, aminoalkoxy, alkylcarbonyl, haloalkylcarbonyl, alkoxycarbonyl, haloalkoxycarbonyl, arylalkyl, aryl, aryloxy, and heterocyclyl, where the aryl and heterocyclyl moieties may be optionally substituted with halogen, alkyl, haloalkyl, alkoxy, or haloalkoxy;
n is an integer from 0 to 2;
R¹ is selected from hydrogen, alkyl, haloalkyl, alkenyl, haloalkenyl, alkenyloxy, alkynyl, alkynyloxy, alkoxy, alkoxyalkyl, haloalkoxy, alkylcarbonyl, alkyloxycarbonyl, alkoxycarbonylalkoxy, arylcarbonyl, aryloxycarbonyl, haloalkoxycarbonyl, carboxyl and arylalkyl; wherein the aryl may be optionally substituted with halogen, alkyl, haloalkyl, alkoxy, or haloalkoxy;
   and wherein 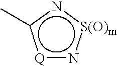
   is a 1,2,5-thiadiazole where Q is CR² or C═R⁴, wherein said 1,2,5-thiadiazole is selected from 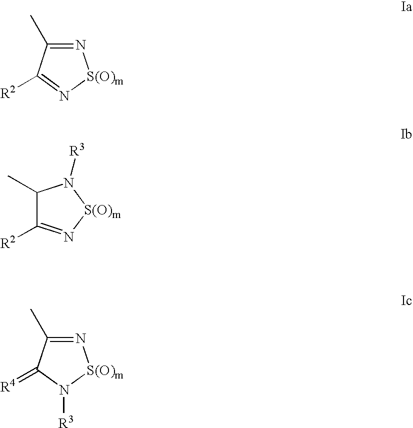
   a 1,2,5-thiadiazol-3-yl a 1,2,5-thiadiazolin-3-yl a 1,2,5-thiadiazolin-3-R⁴-4-yl 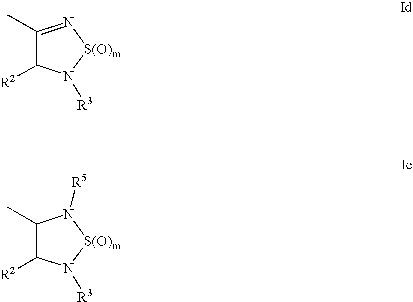
   a 1,2,5-thiadiazolin-4-yl a 1,2,5-thiadiazolidin-3-yl
   where
m is an integer from 0 to 2;
—R² is selected from hydrogen, hydroxy, halogen, amino, nitro, alkyl, haloalkyl, alkenyl, haloalkenyl, alkynyl, haloalkynyl, alkylaryl, alkoxy, haloalkoxy, aryloxy, alkenyloxy, haloalkenyloxy, alkynyloxy; thiol, alkylthio, haloalkylthio, cyanoalkylthio, arylthio, alkenylthio, alkynylthio, alkyloxycarbonyl, carboxyl; —N(R⁶)(R⁷); —NHN(R⁶)(R⁷); —NHC(O)R⁶; —NHC(O)OR⁶; —OC(O)R⁶; where the aryl may be optionally substituted with halogen, alkyl, haloalkyl, alkoxy, cyano, or haloalkoxy moiety;
   where
R⁶ and R⁷ are independently selected from hydrogen, alkyl, arylalkyl, alkoxy, acetyl, alkoxycarbonyl, alkoxyalkyl, aminoalkyl, and carbonylamino;
—R³ and R⁵ are independently selected from hydrogen, hydroxy, alkyl, alkoxy, alkoxyalkyl, aryl, arylalkyl, —N(R⁸)(R⁹); —NHC(O)R⁸ and —NHC(O)OR⁸; where the aryl may be optionally substituted with halogen, alkyl, haloalkyl, alkoxy, cyano, or haloalkoxy moiety;
   where
   R⁸ and R⁹ are independently selected from hydrogen, alkyl, arylalkyl, alkoxy, acetyl, alkoxycarbonyl, alkoxyalkyl, aminoalkyl, and aminocarbonyl; or are taken together with R¹ to form a hetero-atom link;
—R⁴ is selected from O, S and NR¹⁰;
   where
   R¹⁰ is selected from hydrogen, alkyl, alkoxy, alkoxyalkyl, alkenyl, alkynyl, alkenyloxy, alkynyloxy, aryl and arylalkyl;
      and
      the corresponding agriculturally acceptable salts thereof.

The present invention also relates to a method of controlling insects and acarids that comprises applying an insecticidally or acaricidally effective amount of the above composition to a locus of crops, such as cotton, vegetables or fruits, where control of insects and/or acarids is desired.

### DETAILED DESCRIPTION OF THE INVENTION

The present invention relates to compositions containing a pesticidally effective amount of a substituted 1,2,5-thiadiazole derivative or their agriculturally acceptable salts, in admixture with at least one agriculturally acceptable extender or adjuvant. These compositions are surprisingly effective as pesticides, i.e., as acaricides and insecticides. The 1,2,5-thiadiazole derivatives useful in the compositions of the present invention may be represented by the following formula I: 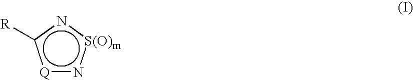
where
—R is an azacycle selected from: 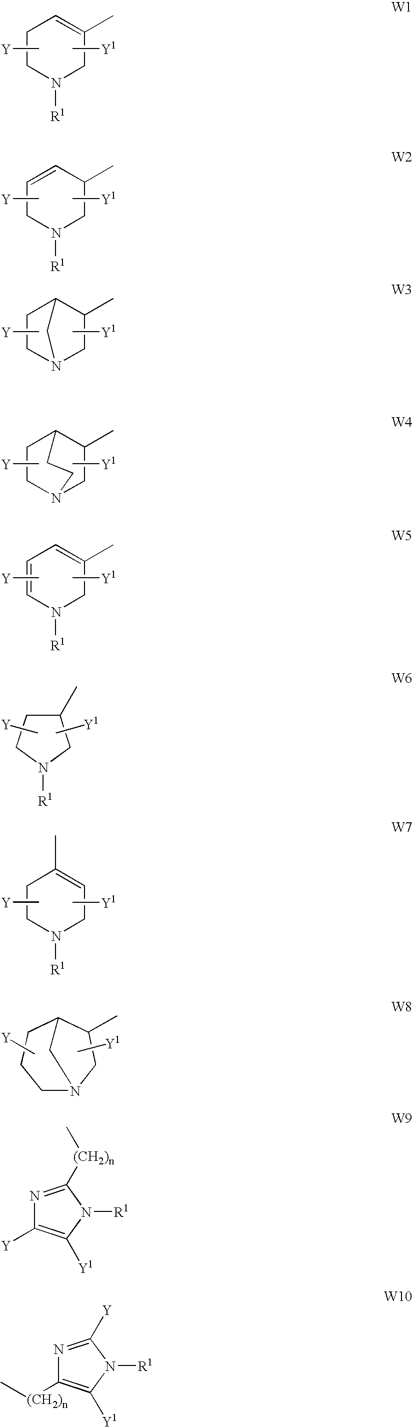 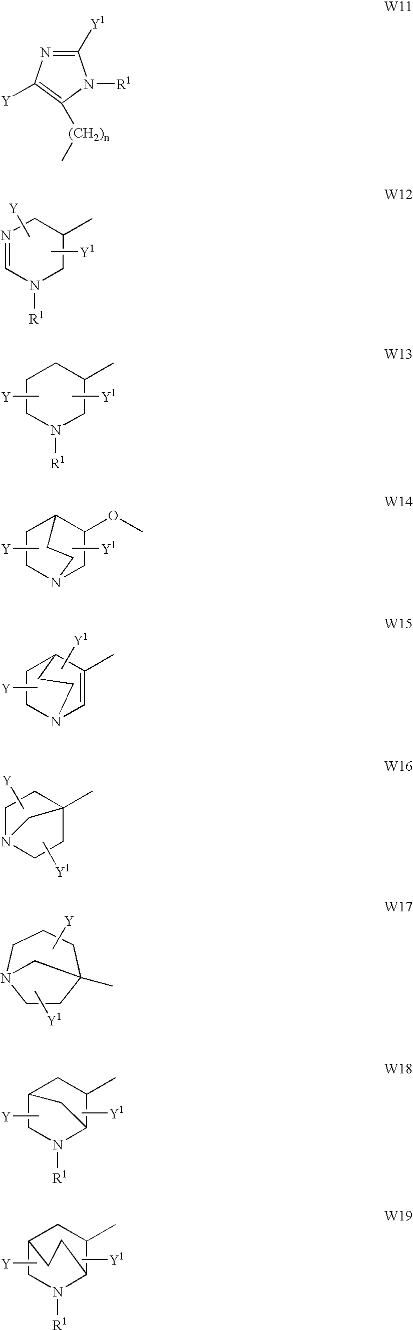 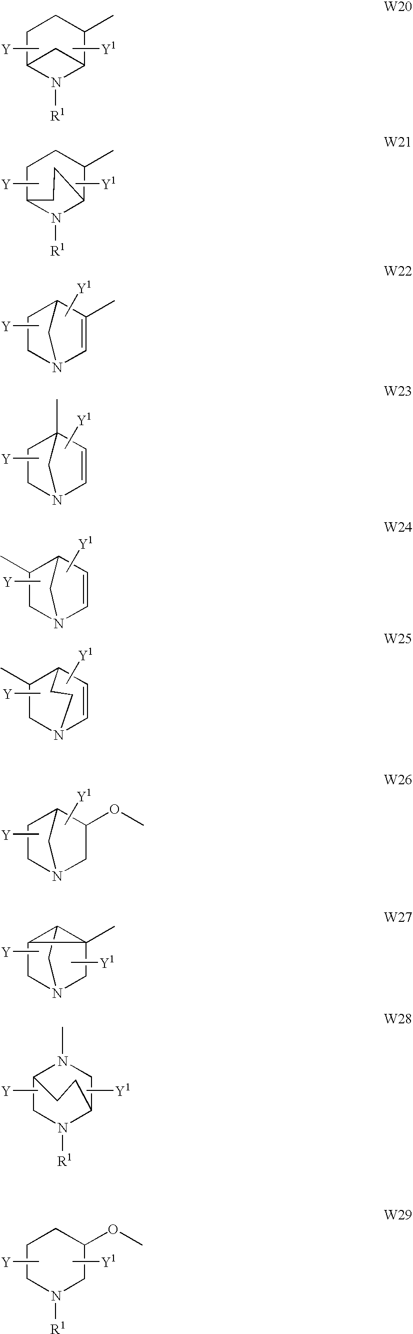
   where
—Y and Y′ may be attached at the same or different positions, and are independently selected from hydrogen, halogen, cyano, nitro, amino, carboxyl, alkyl, haloalkyl, alkenyl, alkoxy, haloalkoxy, aminoalkoxy, alkylcarbonyl, haloalkylcarbonyl, alkoxycarbonyl, haloalkoxycarbonyl, arylalkyl, aryl, aryloxy, and heterocyclyl, where the aryl and heterocyclyl moieties may be optionally substituted with halogen, alkyl, haloalkyl, alkoxy, or haloalkoxy;
n is an integer from 0 to 2;
R¹ is selected from hydrogen, alkyl, haloalkyl, alkenyl, haloalkenyl, hydroxyalkenyloxy, alkynyl, alkynyloxy, alkoxy, alkoxyalkyl, haloalkoxy, alkylcarbonyl, alkyloxycarbonyl, alkoxycarbonylalkoxy, arylcarbonyl, aryloxycarbonyl, haloalkoxycarbonyl, carboxyl and arylalkyl; wherein the aryl may be optionally substituted with halogen, alkyl, haloalkyl, alkoxy, or haloalkoxy;
   and wherein 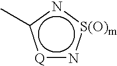
   is a 1,2,5-thiadiazole where Q is CR² or C═R⁴, wherein said 1,2,5-thiadiazole is selected from 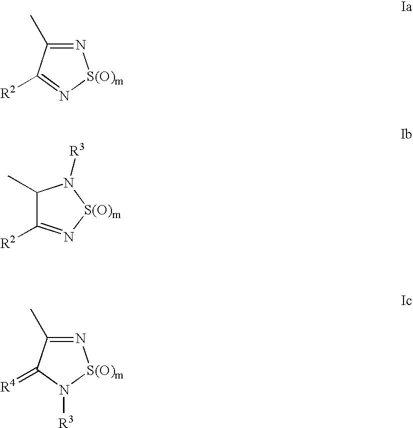
   a 1,2,5-thiadiazol-3-yl a 1,2,5-thiadiazolin-3-yl a 1,2,5-thiadiazolin-3-R⁴-4-yl 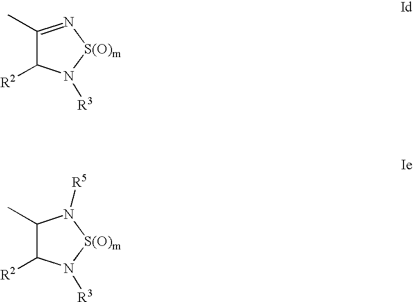
   a 1,2,5-thiadiazolin-4-yl a 1,2,5-thiadiazolidin-3-yl
   where
m is an integer from 0 to 2;
—R² is selected from hydrogen, hydroxy, halogen, amino, nitro, alkyl, haloalkyl, alkenyl, haloalkenyl, alkynyl, haloalkynyl, alkylaryl, alkoxy, haloalkoxy, aryloxy, alkenyloxy, haloalkenyloxy, alkynyloxy; thiol, alkylthio, haloalkylthio, cyanoalkylthio, arylthio, alkenylthio, alkynylthio, alkyloxycarbonyl, carboxyl; —N(R⁶)(R⁷); —NHN(R⁶)(R⁷); —NHC(O)R⁶; —NHC(O)OR⁶; —OC(O)R⁶; where the aryl may be optionally substituted with halogen, alkyl, haloalkyl, alkoxy, cyano, or haloalkoxy moiety;
   where
   R⁶ and R⁷ are independently selected from hydrogen, alkyl, arylalkyl, alkoxy, acetyl, alkoxycarbonyl, alkoxyalkyl, aminoalkyl, and carbonylamino;
—R³ and R⁵ are independently selected from hydrogen, hydroxy, alkyl, alkoxy, alkoxyalkyl, aryl, arylalkyl, —N(R⁸)(R⁹); —NHC(O)R⁸ and —NHC(O)OR⁸; where the aryl may be optionally substituted with halogen, alkyl, haloalkyl, alkoxy, cyano, or haloalkoxy moiety;
   where
   R⁵ and R⁹ are independently selected from hydrogen, alkyl, arylalkyl, alkoxy, acetyl, alkoxycarbonyl, alkoxyalkyl, aminoalkyl, and aminocarbonyl; or are taken together with R¹ to form a hetero-atom link;
—R⁴ is selected from O, S and NR¹⁰;
   where
   R¹⁰ is selected from hydrogen, alkyl, alkoxy, alkoxyalkyl, alkenyl, alkynyl, alkenyloxy, alkynyloxy, aryl and arylalkyl;
      and
      the corresponding agriculturally acceptable salts thereof.

According to nomenclature used to name organic molecules, those moieties designated as Ia-Ie above are not always named as 1,2,5-thiadiazoles. Moieties Ib-Id are often named as 1,2,5-thiadiazolines, whereas moiety le may be named as a 1,2,5-thiadiazolidine. For purposes of the present invention, moieties la-Ie are all referred to as “1,2,5-thiadiazoles” and derivatives thereof.

Agriculturally acceptable salts of the 1,2,5-thiadiazole derivatives of the present invention include, without limitation, iodide and bromide salts and the salts of hydrochloric acid, hydrobromic acid, hydroiodic acid, ethanesulfonic acid, trifluoroacetic acid, methylbenzenesulfonic acid, phosphoric acid, gluconic acid, pamoic acid, and carboxylic acid.

Preferred compositions comprised of the 1,2,5-thiadiazole derivatives of the present invention, selected from those set forth above, are those where the azacycle R is selected from W1, W3, W4, W8; W10 and W11, where n is 1 or 2; W13, W14, W15, W20, W26, W28 and W29;

where

—Y and Y¹ are independently selected from hydrogen and halogen;
—R¹ is selected from hydrogen, alkyl, haloalkyl, alkoxyalkyl, arylalkyl, alkenyl, haloalkenyl, alkynyl, alkylcarbonyl and alkoxycarbonyl;
   and,
the 1,2,5-thiadiazole is selected from i) Ia, where m is 0, and ii) lb and Id, where m is 0 or 2;
   where
—R² is selected from hydrogen, halogen, alkoxy, alkenyloxy, alkynyloxy, alkylthio, alkenylthio, and alkynylthio;
   and
—R³ is selected from hydrogen, hydroxy, alkyl, alkoxyalkyl, aryl and N(R⁹)(R⁹);
   where
R⁸ and R⁹ are independently selected from hydrogen, alkyl, alkoxy and alkoxyalkyl.

More preferred compositions comprised of the 1,2,5-thiadiazole derivatives of the present invention, selected from those set forth above, are those where the azacycle R is selected from W1, W3, W4, W13, W14 and W26, where Y and Y¹ are hydrogen and R¹ is selected from hydrogen, alkyl, haloalkyl, alkoxyalkyl, alkylcarbonyl, alkoxycarbonyl and arylalkyl; and said 1,2,5-thiadiazole is selected from i) Ia, where m 0.

Yet more preferred compositions comprised of the 1,2,5-thiadiazole derivatives are those compositions where the azacycle R is selected from W1, W3 and W4; R¹ is selected from alkyl, haloalkyl, alkoxyalkyl and arylalkyl; and R² is selected from hydrogen, halogen, alkoxy, alkynyloxy and alkynylthio.

More specifically, compositions containing an insecticidally and acaricidally effective amount of a substituted 1,2,5-thiadiazole derivative and their agriculturally acceptable salts, in admixture with at least one agriculturally acceptable extender or adjuvant are surprisingly effective as acaricides and insecticides. The 1,2,5-thiadiazole derivatives may be represented by the following formula I: 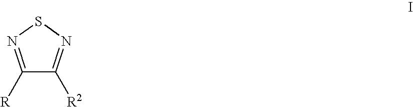
where R is an azacycle selected from the following: 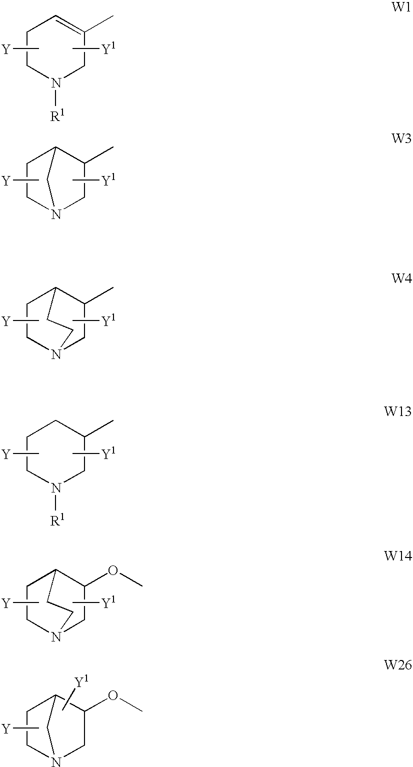
where
—Y and Y¹ are hydrogen;
R¹ is selected from hydrogen, alkyl, haloalkyl, alkoxyalkyl, alkylcarbonyl, alkoxycarbonyl and arylalkyl;
   and
—R² is selected from hydrogen, halogen, alkoxy, alkenyloxy, alkynyloxy, alkylthio, alkenylthio, and alkynylthio.

Preferred compositions comprised of the 1,2,5-thiadiazole derivatives of the present invention, selected from those set forth above, are those where the azacycle R is selected from W1, W3 and W4; R¹ is selected from hydrogen, alkyl, haloalkyl, alkoxyalkyl and arylalkyl; and R² is selected from hydrogen, halogen, alkoxy, alkynyloxy and alkynylthio; more preferably where R¹ is selected from hydrogen and alkyl, and R² is selected from hydrogen, chlorine, fluorine, alkoxy and alkynyloxy.

As used in this specification and unless otherwise indicated, the substituent terms “alkyl” and “alkoxy”, alone or as part of a larger moiety, include chains of 1 to 14 carbon atoms, preferably straight or branched alkyls of 1 to 6 carbon atoms; while “halogen” or “halo”, alone or as part of a larger moiety, includes chlorine, bromine, fluorine, and iodine atoms. The terms “alkenyl” or “alkynyl”, used alone or as part of a larger moiety, includes straight or branched chains of at least two carbon atoms containing at least one carbon-carbon double or triple bond, preferably up to 12 carbon atoms, more preferably, up to ten carbon atoms, most preferably up to seven carbon atoms. The term “cycloalkyl” includes rings of three to twelve carbon atoms, preferably rings of three to six carbon atoms. The terms “haloalkyl” and “haloalkoxy”, alone or as part of a larger moiety, include straight or branched chain alkyls of 1 to 14 carbon atoms, preferably lower straight or branched chain alkyls of 1 to 6 carbon atoms, wherein one or more hydrogen atoms have been replaced with halogen atoms, as, for example, trifluoromethyl or 2,2,2-trifluoroethoxy, respectively. “Aryl” refers to an aromatic ring structure, including fused rings, having 5 to 10 carbon atoms. “Heterocyclyl” refers to an aromatic ring structure, including fused rings, having at least one nitrogen, sulfur or oxygen atom. “Amino” refers to compounds of nitrogen that may be considered derived from ammonia and includes primary, secondary and tertiary amines wherein one or more of the hydrogen atoms is replaced with alkyl groups. “THF” refers to tetrahydrofuran, “DMF” refers to N,N-dimethylformamide, “MeOH” refers to methanol, “EtOH” refers to ethanol, “DMAC” refers to N,N-dimethylacetamide, and “TEA” refers to triethylamine. The term “pesticide” or “pesticidal” refers to insecticide, acaricide or insecticidal and acaricidal, respectively. The term “pesticidally effective amount” refers to an insecticidally effective amount and an acaricidally effective amount, and as used in the context of the present invention, refers to a rate of application of a compound of the present invention applied to a locus where insect and acarid control is needed. Such a pesticidally effective amount in the context of the present invention is in the range of 10 ppm to 1000 ppm. Of course, one skilled in the art will realize that the pesticidally effective amount may not be the same to control both insects and acarids.

The compounds of the present invention may be synthesized by methods that are individually known to those skilled in the art from intermediate compounds readily available in commerce. Many of the compounds of the present invention in which R is an azabicyclyl are prepared in the manner shown in Schema 1, as set forth below:

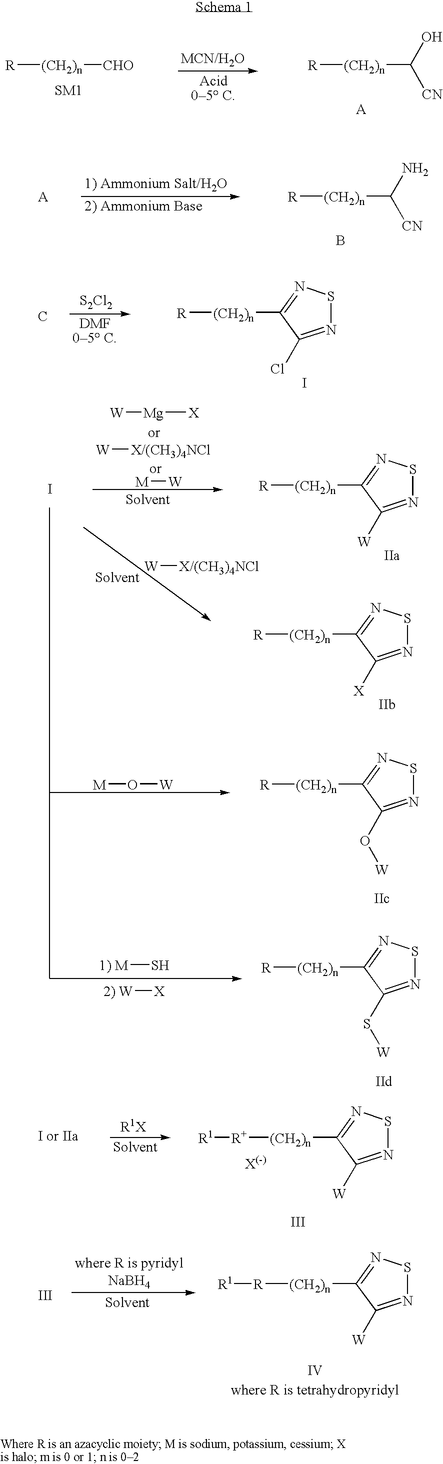

As depicted in Schema 1, a substituted azacyclycarboxyaldehyde (SM1) is reacted with a cyanide complex, for example, potassium cyanide, in an acid, for example, acetic acid, at 0-5° C. to yield the appropriately substituted hydroxyazacyclylalkylnitrile (A). The appropriately substituted hydroxyazacyclylalkylnitrile (A) is then reacted with an ammonium salt, for example, ammonium chloride, in water followed by an ammonium base, for example ammonium hydroxide, to yield the appropriately substituted aminoazacyclylalkylnitrile (B). The appropriately substituted aminoazacyclylalkylnitrile (B) is then be reacted with sulfur monochloride in a solvent, for example, DMF or THF, at 0-5° C. to yield the targeted substituted 3-chloro-4-azacyclyl-1,2,5-thiadiazole (I), for example, 3-chloro-4-pyrid-3-yl-1,2,5-thiadiazole.

Appropriately substituted 1,2,5-thiadiazoles may be prepared from (I). The substituted 3-chloro-4-azacyclyl-1,2,5-thiadiazole (1) is then be reacted with: 1) the appropriately substituted magnesium halide, for example, methyl magnesium chloride, or the appropriately substitute metal complex in a solvent, for example, DMF or THF, to yield the targeted 3-substituted-4-azacyclyl-1,2,5-thiadiazole (IIa), for example -4-pyrid-3-yl-1,2,5-thiadiazole; 2) the appropriately substituted halide, for example, potassium fluoride, in the presence of tetramethylammonium chloride in a solvent, for example, DMF, to yield the targeted 3-substituted-4-azacyclyl-1,2,5-thiadiazole (IIa) or the targeted 3-halo-4-azacyclyl-1,2,5-thiadiazole (IIb), for example, 3-fluoro-4-azacyclyl-1,2,5-thiadiazole; 3) the appropriately substituted metal oxa complex to yield the targeted 3-substituted oxa-4-azacyclyl-1,2,5-thiadiazole (IIc); a metal sulfur complex followed by the appropriately substituted halide to yield the targeted 3-substituted thio-4-azacyclyl-1,2,5-thiadiazole (IId).

Agriculturally acceptable salts of the 1,2,5-thiadiazoles may be prepared by reacting the 3-chloro-4-azacyclyl-1,2,5-thiadiazole (1) or the 3-substituted-4-azacyclyl-1,2,5-thiadiazole (IIa) with the appropriately substituted halide, for example, benzyl bromide or methyl iodide, to yield the targeted salt of the 3-substituted-4-azacyclyl-1,2,5-thiadiazole (III), for example, the bromide salt of 3-chloro-4-(1-benzylpyrid-3-yl)-1,2,5-thiadiazole or the iodide salt of 3-fluoro-4-(1-methylpyrid-3-yl)-1,2,5-thiadiazole. When the azacyclyl is a pyridyl, it may be reacted with sodium borohydride in a solvent, for example, THF, MeOH, or EtOH, to form the targeted 3-substituted-4-tetrahydropyridyl-1,2,5-thiadiazole (I), for example, 3-chloro-4-[1-benzyl(1,2,5,6-tetrahydropyrid-3-yl)]-1,2,5-thiadiazole or 3-fluoro-4-(1-methyl-1,2,5,6-tetrahydropyrid-3-yl)-1,2,5-thiadiazole.

Compounds of the present invention in which R is a bridged azacyclyl are prepared in a manner shown in Schema 2, as set forth below:

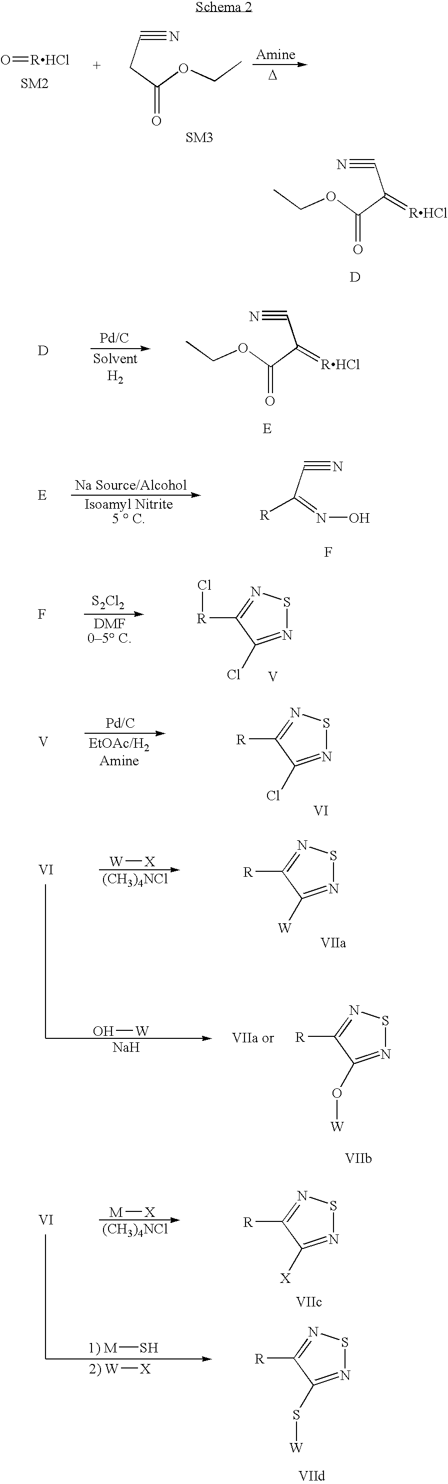

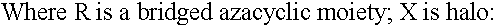

As depicted in Schema 2, compounds of the present invention wherein R is a bridged azacyclyl moiety are prepared by reacting the appropriately substituted oxo-containing bridged azacyclyl compound (SM2), for example, 3-quinuclidinone hydrochloride, with ethyl cyanoacetate (SM3) in the presence of an amine, for example, TEA, at elevated temperature to form the appropriately substituted ethyl 2-cyano-2-(bridged azacyclyl)-ylideneacetate hydrochloride (D)). The appropriately substituted ethyl 2-cyano-2-(bridged azacyclyl)ylideneacetate hydrochloride (D) is then hydrogenated with palladium on carbon in a solvent, for example, EtOH or methylene chloride, to yield the appropriately substituted ethyl 2-cyano-2-(bridged azacyclyl)acetate hydrochloride (E), for example, ethyl 2-cyano-2-quinuclidin-3-ylacetate. The substituted ethyl 2-cyano-2-(bridged azacyclyl)acetate hydrochloride (E), is then reacted with a sodium source in the presence of isoamyl nitrite at 5° C. to yield the appropriately substituted 2-(hydroxyimino)-2-(bridged azacyclyl)ethanenitrile (F) which is then reacted with sulfur monochloride in DMF in the manner described above to yield the targeted 3-chloro-4-(chloro substituted bridged azacyclyl)-1,2,5-thiadiazole (V), for example, 3-chloro-4-(3-chloroquinuclidin-3-yl)-1,2,5-thiadiazole. The 3-chloro-4-(chloro substituted bridged azacyclyl)-1,2,5-thiadiazole (V) may then be hydrogenated with palladium on carbon in the presence of an amine in the manner described above to yield the targeted 3-chloro-4-(bridged azacyclyl)-1,2,5-thiadiazole (VI), for example, 3-chloro-4-quinuclidin-3-yl-1,2,5-thiadiazole.

Similar to above, appropriately substituted 1,2,5-thiadiazoles may be prepared (VI). The 3-chloro-4-(bridged azacyclyl)-1,2,5-thiadiazole (VI) may then be reacted with: 1) the appropriately substituted halide in the presence of tetramethylammonium chloride in the manner described above to yield the targeted 3-substituted-4-(bridged azacyclyl)-1,2,5-thiadiazole (VIIa) or the targeted 3-halo-4-(bridged azacyclyl)-1,2,5-thiadiazole (VIIc); 2) the appropriately substituted alochol, for example, n-butanol or ethanol, in the presence of sodium hydride to yield the targeted 3-substituted-4-(bridged azacyclyl)-1,2,5-thiadiazole (IIVa) or the targeted 3-subtituted oxy-4-(bridged azacyclyl)-1,2,5-thiadiazole (VIIb), for example, 3-butoxy-4-quinuclidin-3-yl-1,2,5-thiadiazole; or 3) a metal sulfur complex and appropriately substituted halide in the manner described above to yield the targeted 3-substituted thio-4-(bridged azacyclyl)-1,2,5-thiadiazole (VIId).

Compounds of the present invention, where for example, the five-membered heterocyclic portion of the molecule contains a ketone or thioketone moiety may be prepared by a method set forth in Schema 3 below:

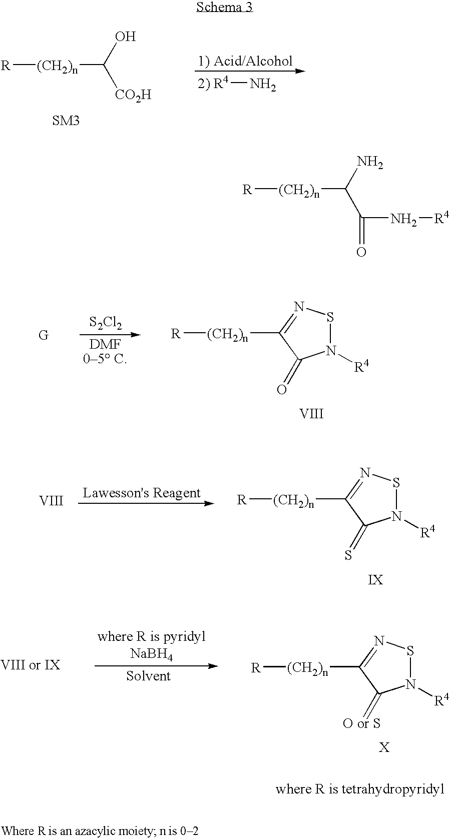

As depicted in Schema 3, a substituted 2-amino-(2-azacyclylalkyl) acetic acid (SM3), for example, 2-amino-2-(3-pyridyl)acetic acid, is reacted with an acid, for example, hydrochloric acid, in an alcohol, for example, ethanol, followed by the appropriately substituted amine to yield the appropriately substituted 2-amino-(2-azacyclylalkyl)acetamide (G). The appropriately substituted 2-amino-(2-azacyclylalkyl)acetamide (G) is then reacted with sulfur monochloride in a solvent, for example, DMF or THF, in the manner described above to yield the targeted substituted 4-azacyclyl-1,2,5-thiadiazolin-3-one (VIII). The appropriately substituted 4-azacyclyl-1,2,5-thiadiazolin-3-one (VIII) is then reacted with Lawesson's Reagent to yield the target 4-azacyclyl-1,2,5-thiadiazolin-3-thione (IX). When the azacyclyl moiety is a pyridyl, it may be reacted with sodium borohydride in a solvent, for example, TEF, MeOH, or EtOH, in the manner described above to form the targeted 4-tetrahydropyridyl-1,2,5-thiadiazolin-3-one or 4-tetrahydropyridyl-1,2,5-thiadiazolin-3-thione (X).

The compositions of the present invention are those compositions that are normally employed in the art for facilitating the dispersion of active ingredients for the particular utility desired, recognizing the fact that the composition and mode of application of a toxicant may affect the activity of the material in a given application. Thus, for agricultural use the present insecticidal and acaricidal compositions may be granules of relatively large particle size, water-soluble or water-dispersible granules, powdery dusts, wettable powders, emulsifiable concentrates, solutions, or as any of several other known types of compositions, depending on the desired mode of application.

These insecticidal and acaricidal compositions may be applied either as water-diluted sprays, or dusts, or granules to the areas in which insect and arachnid control is desired. These compositions may contain as little as 0.1%, 0.2% or 0.5% to as much as 95% or more by weight of active ingredient.

Dusts are free flowing admixtures of the active ingredients with finely divided solids such as talc, natural clays, kieselguhr, flours such as walnut shell and cottonseed flours, and other organic and inorganic solids which act as dispersants and carriers for the toxicant; these finely divided solids have an average particle size of less than about 50 microns. A typical dust composition useful herein is one containing 1.0 part or less of the insecticidal and acaricidal compound and 99.0 parts of talc.

Wettable powders are in the form of finely divided particles which disperse readily in water or other dispersant. The wettable powder is ultimately applied to the locus where insect and arachnid control is desired either as a dry dust or as an emulsion in water or other liquid. Typical carriers for wettable powders include Fuller's earth, kaolin clays, silicas, and other highly absorbent, readily wet, inorganic diluents. Wettable powders normally are prepared to contain about 5-80% of active ingredient, depending on the absorbency of the carrier, and usually also contain a small amount of a wetting, dispersing, or emulsifying agent to facilitate dispersion. For example, a useful wettable powder composition contains 80.8 parts of the insecticidal and acaricidal compound, 17.9 parts of Palmetto clay, and 1.0 part of sodium lignosulfonate and 0.3 part of sulfonated aliphatic polyester as wetting agents.

Other useful compositions for insecticidal and acaricidal applications are emulsifiable concentrates (ECs) which are homogeneous liquid compositions dispersible in water or other dispersant, and may consist entirely of the insecticidal and acaricidal compound and a liquid or solid emulsifying agent, or may also contain a liquid carrier, such as xylene, heavy aromatic naphthas, isophorone, or other non-volatile organic solvent. For insecticidal and acaricidal application these concentrates are dispersed in water or other liquid carrier, and normally applied as a spray to the area to be treated. The percentage by weight of the essential active ingredient may vary according to the manner in which the composition is to be applied, but in general comprises 0.5 to 95% of active ingredient by weight of the insecticidal and acaricidal composition.

Flowable compositions are similar to ECs except that the active ingredient is suspended in a liquid carrier, generally water. Flowables, like ECs, may include a small amount of a surfactant, and contain active ingredient in the range of 0.5 to 95%, frequently from 10 to 50%, by weight of the composition. For application, flowables may be diluted in water or other liquid vehicle, and are normally applied as a spray to the area to be treated.

Typical wetting, dispersing, or emulsifying agents used in agricultural compositions include, but are not limited to, the alkyl and alkylaryl sulfonates and sulfates and their sodium salts; alkylaryl polyether alcohols; sulfated higher alcohols; polyethylene oxides; sulfonated animal and vegetable oils; sulfonated petroleum oils; fatty acid esters of polyhydric alcohols and the ethylene oxide addition products of such esters; and the addition product of long-chain mercaptans and ethylene oxide. Many other types of useful surface-active agents are available in commerce. The surface-active agents, when used, normally comprise from 1 to 15% by weight of the composition.

Other useful compositions include suspensions of the active ingredient in a relatively non-volatile solvent such as water, corn oil, kerosene, propylene glycol, or other suitable solvents.

Still other useful compositions for insecticidal and acaricidal applications include simple solutions of the active ingredient in a solvent in which it is completely soluble at the desired concentration, such as acetone, alkylated naphthalenes, xylene, or other organic solvents. Granular compositions, wherein the toxicant is carried on relatively coarse particles, are of particular utility for aerial distribution or for penetration of cover crop canopy. Pressurized sprays, typically aerosols wherein the active ingredient is dispersed in finely divided form as a result of vaporization of a low boiling dispersant solvent carrier, such as carbon dioxide, propane, or butane, may also be used. Water-soluble or water-dispersible granules are also useful compositions for insecticidal and acaricidal application of the present compounds. Such granular compositions are free-flowing, non-dusty, and readily water-soluble or water-miscible. The soluble or dispersible granular compositions described in U.S. Pat. No. 3,920,442 are useful herein with the present insecticidal and acaricidal compounds. In use by the farmer on the field, the granular compositions, emulsifiable concentrates, flowable concentrates, solutions, etc., may be diluted with water to give a concentration of active ingredient in the range of say 0.1% or 0.2% to 1.5% or 2%.

The active insecticidal compounds of this invention may be formulated and/or applied with one or more second compounds. Second compounds include, but are not limited to, other pesticides, plant growth regulators, fertilizers, soil conditioners, or other agricultural chemicals. In applying an active compound of this invention, whether formulated alone or with other agricultural chemicals, an effective amount and concentration of the active compound is of course employed; the amount may vary in the range of, e.g. about 0.02 to about 1.5 kg/ha, preferably about 0.05 to about 0.3 kg/ha. For field use, where there are losses of insecticide, higher application rates (e.g., four times the rates mentioned above) may be employed.

When the active insecticidal compounds of the present invention are used in combination with one or more of second compounds, e.g., with other pesticides such as herbicides, the herbicides include, without limitation, for example: N-(phosphonomethyl)glycine (“glyphosate”); aryloxyalkanoic acids such as (2,4-dichlorophenoxy)acetic acid (“2,4-D″), (4-chloro-2-methylphenoxy)acetic acid (“MCPA”), (+/−)-2-(4chloro-2-methylphenoxy)propanoic acid (“MCPP”); ureas such as N,N-dimethyl-N′-[4-(1-methylethyl)phenyl]urea (“isoproturon”); imidazolinones such as 2-[4,5-dihydro-4-methyl-4-(1-methylethyl)-5-oxo-1H-imidazol-2-yl]-3-pyridinecarboxylic acid (“imazapyr”), a reaction product comprising (+/−)-2-[4,5-dihydro-4-methyl-4-(1-methylethyl)-5-oxo-1H-imidazol-2-yl]-4-methylbenzoic acid and (+/−)2-[4,5-dihydro-4-methyl-4-(1-methylethyl)-5-oxo-1H-imidazol-2-yl]-5-methylbenzoic acid (“imazamethabenz”), (+/−)-2-[4,5-dihydro-4-methyl-4-(1-methylethyl)-5-oxo-1H-imidazol-2-yl]-5-ethyl-3-pyridinecarboxylic acid (“imazethapyr”), and (+/−)-2-[4,5-dihydro-4-methyl-4-(1-methylethyl)-5-oxo-1H-imidazol-2-yl]-3-quinolinecarboxylic acid (“imazaquin”); diphenyl ethers such as 5-[2-chloro-4-(trifluoromethyl)phenoxy]-2-nitrobenzoic acid (“acifluorfen”), methyl 5-(2,4-dichlorophenoxy)-2-nitrobenzoate (“bifenox”), and 5-[2-chloro-4-(trifluoromethyl)phenoxy]-N-(methylsulfonyl)-2-nitrobenzamide (“fomasafen”); hydroxybenzonitriles such as 4-hydroxy-3,5-diiodobenzonitrile (“ioxynil”) and 3,5-dibromo-4-hydroxybenzonitrile (“bromoxynil”); sulfonylureas such as 2-[[[[(4chloro-6-methoxy-2-pyrimidinyl)amino]carbonyl]amino]sulfonyl]benzoic acid (“chlorimuron”), 2-chloro-N-[[(4-methoxy-6-methyl-1,3,5-triazin-2-yl)amino]carbonyl]benzenesulfonamide(achlorsulfuron”), 2-[[[[[(4,6-dimethoxy-2-pyrimidinyl)amino]carbonyl)amino]sufonyl]methyl]benzoic acid (“bensulfuron”), 2-[[[[(4,6-dimethoxy-2-pyrimidinyl)amino]carbonyl]amino]sulfonyl]-1-methy-1H-pyrazol-4-carboxylic acid (“pyrazosulfuron”), 3-[[[[(4-methoxy-6-methyl-1,3,5-triazin-2-yl)amino]carbonyl]amino]sulfonyl]-2-thiophenecarboxylic acid (“thifensulfuron”), and 2-(2-chloroethoxy)-N[[(4-methoxy-6-methyl-1,3,5-triazin-2-yl)amino]carbonyl]benzenesulfonamide (“triasulfuron”); 2-(4-aryloxy-phenoxy)alkanoic acids such as (+/−)-2[4-[(6-chloro-2-benzoxazolyl)oxy]phenoxy]-propanoic acid (fenoxaprop”), (+/−)-2-[4[[5-(trifluoromethyl)-2-pyridinyl]oxy]-phenoxy]propanoic acid (“fluazifop”), (+/−)-2-[4-(6-chloro-2-quinoxalinyl)oxy]-phenoxy]propanoic acid (“quizalofop”), and (+/−)-2-[(2,4-dichlorophenoxy)phenoxy]propanoic acid (“diclofop”); benzothiadiazinones such as 3-(1-methylethyl)-1H-1,2,3-benzothiadiazin-4(3H)-one-2,2-dioxide (“bentazone”); 2-chloroacetanilides such as N-(butoxymethyl)-2-chloro-N-(2,6-diethylphenyl)acetamide (“butachlor”), 2-chloro-N-(2-ethyl-6-methylphenyl)-N-(2-methoxy-1-methylethyl)acetamide (“metolachlor”), 2-chloro-N-(ethoxymethyl)-N-(2-ethyl-6-methylphenyl)acetamide (“acetochlor”), and (RS)-2-chloro-N-(2,4-dimethyl-3-thienyl)-N-(2-methoxy-1-methylethyl)acetamide (“dimethenamide”); arenecarboxylic acids such as 3,6-dichloro-2-methoxybenzoic acid (“dicamba”); pyridyloxyacetic acids such as [(4-amino-3,5-dichloro-6-fluoro-2-pyridinyl)oxy]acetic acid (“fluroxypyr”), and other herbicides.

When the active insecticidal compounds of the present invention are used in combination with one or more of second compounds, e.g., with other pesticides such as other insecticides, the other insecticides include, for example: organophosphate insecticides, such as chlorpyrifos, diazinon, dimethoate, malathion, parathion-methyl, and terbufos; pyrethroid and non-pyrethroid insecticides, such as fenvalerate, deltamethrin, fenpropathrin, cyfluthrin, flucythrinate, alpha-cypermethrin, bifenthrin, cypermethrin, resolved cyhalothrin, etofenprox, esfenvalerate, tralomethrin, tefluthrin, cycloprothrin, betacyfluthrin, acrinathrin and silafluofen; carbamate insecticides, such as aldicarb, carbaryl, carbofuran, and methomyl; organochlorine insecticides, such as endosulfan, endrin, heptachlor, and lindane; benzoylurea insecticides, such as diflubenuron, triflumuron, teflubenzuron, chlorfluazuron, flucycloxuron, hexaflumuron, noviflumuron, flufenoxuron, and lufenuron; and other insecticides, such as, without limitation, amitraz, clofentezine, fenpyroximate, hexythiazox, cyhexatin, spinosad, imidacloprid, chlorfenaptr, hydramethylon, acequinocyl, fenbutatin-oxide, methoxyfenozide, tebufenozide, halofenozide, indoxacarb, fipronyl, ethiprole, etoxazole, bifenazate, spirodiclofen, spiromesifen, methoprene, pyriproxyfen, fenoxycarb, pymetrozine, abamectin, emamectin benzoate, milbemectin, and other insecticides.

When the active insecticidal compounds of the present invention are used in combination with one or more of second compounds, e.g., with other pesticides such as fungicides, the fungicides include, for example: benzimidazole fungicides, such as benomyl, carbendazim, thiabendazole, and thiophanate-methyl; 1,2,4-triazole fungicides, such as epoxyconazole, cyproconazole, flusilazole, flutriafol, propiconazole, tebuconazole, triadimefon, and triadimenol; substituted anilide fungicides, such as metalaxyl, oxadixyl, procymidone, and vinclozolin; organophosphorus fungicides, such as fosetyl, iprobenfos, pyrazophos, edifenphos, and tolclofos-methyl; morpholine fungicides, such as fenpropimorph, tridemorph, and dodemorph; other systemic fungicides, such as fenarimol, imazalil, prochloraz, tricyclazole, and triforine; dithiocarbamate fungicides, such as mancozeb, maneb, propineb, zineb, and ziram; non-systemic fungicides, such as chlorothalonil, dichlofluanid, dithianon, and iprodione, captan, dinocap, dodine, fluazinam, gluazatine, PCNB, pencycuron, quintozene, tricylamide, and validamycin; inorganic fungicides, such as copper and sulphur products, and other fungicides.

When the active insecticidal compounds of the present invention are used in combination with one or more of second compounds, e.g., with other pesticides such as nematicides, the nematicides include, for example: carbofuran, carbosulfan, turbufos, aldecarb, ethoprop, fenamphos, oxamyl, isazofos, cadusafos, and other nematicides.

When the active insecticidal compounds of the present invention are used in combination with one or more of second compounds, e.g., with other materials such as plant growth regulators, the plant growth regulators include, for example: maleic hydrazide, chlormequat, ethephon, gibberellin, mepiquat, thidiazon, inabenfide, triaphenthenol, paclobutrazol, unaconazol, DCPA, prohexadione, trinexapac-ethyl, and other plant growth regulators.

Soil conditioners are materials which, when added to the soil, promote a variety of benefits for the efficacious growth of plants. Soil conditioners are used to reduce soil compaction, promote and increase effectiveness of drainage, improve soil permeability, promote optimum plant nutrient content in the soil, and promote better pesticide and fertilizer incorporation. When the active insecticidal compounds of the present invention are used in combination with one or more of second compounds, e.g., with other materials such as soil conditioners, the soil conditioners include organic matter, such as humus, which promotes retention of cation plant nutrients in the soil; mixtures of cation nutrients, such as calcium, magnesium, potash, sodium, and hydrogen complexes; or microorganism compositions which promote conditions in the soil favorable to plant growth. Such microorganism compositions include, for example, bacillus, pseudomonas, azotobacter, azospirilluin, rhizobium, and soil-borne cyanobacteria.

Fertilizers are plant food supplements, which commonly contain nitrogen, phosphorus, and potassium. When the active insecticidal compounds of the present invention are used in combination with one or more of second compounds, e.g., with other materials such as fertilizers, the fertilizers include nitrogen fertilizers, such as ammonium sulfate, ammonium nitrate, and bone meal; phosphate fertilizers, such as superphosphate, triple superphosphate, ammonium sulfate, and diammonium sulfate; and potassium fertilizers, such as muriate of potash, potassium sulfate, and potassium nitrate, and other fertilizers.

In some cases, the effectiveness of such combinations may be improvement. For example, such combinations may exhibit synergistic effects, reduced rates of application resulting in improved user safety, control a broader spectrum of pests, improved tolerance by plants, and improved tolerance by non-pest species, such as mammals and fish.

The methods of the present invention are predicated on causing an insecticidal or acaricidal amount of a compound of Formula I to be present within insects or acarids and, thereby, killing or controlling the insects or acarids. It is possible and is within the scope of the invention to cause a compound of Formula I wherein R² represents amino (NH₂) to be present within insects or acarids by contacting the insects or acarids with a derivative of that compound, which derivative is converted within the insects or acarids to a compound of Formula I wherein N—R³ and/or N—R⁵ represents NH. Such compounds, which can be referred to as pro-insecticides, include compounds containing an R², R³ and R⁵ substituent that can be converted to NH₂ or NH by chemical processes, such as hydrolysis, oxidation, reduction, and the like, that are either enzymatic or non-enzymatic in nature. Suitable substituents include N-acylamino, N-substituted imino, and N-sulfenyl amino groups, and the like. Some examples, wherein hydrocarbyl refers to an aliphatic or aromatic hydrocarbon moiety optionally substituted with halogen, hydroxy, alkoxy, cyano, or nitro, or the like, are illustrated below: NH—CO(hydrocarbyl); NH—CH(OH)(hydrocarbyl); NH—CO₂(hydrocarbyl); N═CH(hydrocarbyl); NH—CO—NH(hydrocarbyl); NH—S(hydrocarbyl); NH—COCO₂(hydrocarbyl); NH—S—N(hydrocarbyl)₂; NH—C(S-(hydrocarbyl))=N(hydrocarbyl); NH—CH(O-(hydrocarbyl))(hydrocarbyl)

Compounds containing such substituents can be prepared from compounds of Formula I wherein R² represents, for example, NH₂ by well established methods known to those in the art. For example, N-acyl derivatives can be prepared by treatment with an acyl halide or anhydride, N-substituted imino derivatives can be prepared by treatment with aldehydes, urea derivatives can be prepared by treatment with isocyanates, N-sulfenyl derivatives can be prepared by treatment with a sulfenyl chloride, carbamate derivatives can be prepared by treatment with a chloroformate ester, and isothiourea derivatives can be prepared by treatment with first an isothiocyanate and then a hydrocarbyl halide.

It is further possible and within the scope of the invention to cause a compound of Formula I wherein R¹ represents hydrogen (H) to be present within insects or acarids by contacting the insects or acarids with a derivative of that compound, which derivative is converted within the insects or arachnid to a compound of Formula I wherein R¹ represents hydrogen. Such compounds are also pro-insecticides. Suitable compounds include those wherein the C—H hydrogen atom of such compounds is replaced by a substituent that can be removed by hydrolysis, oxidation, or reduction in either enzymatic or non-enzymatic reactions. Typical substituents include alkoxymethyl and alkylthiomethyl groups, alkanoyloxymethyl groups, sulfenyl groups, and sulfeneamino groups. Some examples, wherein hydrocarbyl refers to an aliphatic or aromatic hydrocarbon moiety optionally substituted with halogen, hydroxy, alkoxy, cyano, or nitro, or the like are illustrated below:
CH₂—O(hydrocarbyl); S(hydrocarbyl); N—CH₂—S(hydrocarbyl); S—N(hydrocarbyl)₂; CH₂—OCO(hydrocarbyl); S—N(hydrocarbyl)CO₂(hydrocarbyl)

Compounds of these types can be prepared from compounds of Formula I wherein R¹ represents H by methods well established in the art. For example, alkyloxymethyl, alkylthiomethyl, and alkanoyloxymethyl substituted compounds can be prepared by alkylation with the corresponding chloromethyl alkyl ether, thioether, or ester. The sulfenyl type substituted compounds can be prepared by reaction with the corresponding sulfenyl halide.

It is further possible and within the scope of the invention to cause a compound of Formula I wherein R², R³ and R⁵ represents hydroxy (OH) to be present within insects or acarids by contacting the insects or acarids with a derivative of that compound, which derivative is converted within the insects or acarids to a compound of Formula I wherein R², R³ and R⁵ represents hydroxy. Such compounds are also pro-insecticides. Suitable compounds include compounds containing an R², R³ and R⁵ substituent that can be converted to OH by chemical processes, such as hydrolysis, oxidation, reduction, and the like, that are either enzymatic or non-enzymatic in nature. Typical substituents include acyloxy, carbamoyloxy, and carbonyl. Some examples, wherein hydrocarbyl refers to an aliphatic or aromatic hydrocarbon moiety optionally substituted with halogen, hydroxy, alkoxy, cyano, or nitro, or the like are illustrated below:
O—CO(hydrocarbyl; O—CH₃; O—CO₂(hydrocarbyl); O—C(CH₃)₂—O-hyrdocarboyl; O—C(O)—N(hydrocarbyl)₂; O—CH₂OCH₃; O—C(O)—NH₂; O—CH₂CH═CH₂; O—SO₃⁻M⁺; O—PO₃⁻M⁺

Compounds of these types can be prepared from compounds of Formula I wherein R², R³ and R⁵ represents OH by methods well established in the art. For example, acyloxy derivatives may be prepared by treatment with acid halides or anhydrides; carbamoyloxy derivatives can be prepared by treatment with a carbamoyl chloride; and carbonyl derivatives can be prepared by treatment with a carbonate or chloroformate.

It is further possible and within the scope of the invention to cause a compound of Formula I wherein R² represents mercapto or thiol (SH) to be present within insects or acarids by contacting the insects or acarids with a derivative of that compound, which derivative is converted within the insects or acarids to a compound of Formula I wherein R² represents mercapto. Such compounds are also pro-insecticides. Suitable compounds include compounds containing an R² substituent that can be converted to SH by chemical processes, such as hydrolysis, oxidation, reduction, and the like, that are either enzymatic or non-enzymatic in nature. Typical substituents include acylthio and hydrocarbyloxyalkylthio, wherein hydrocarbyl refers to an aliphatic or aromatic hydrocarbon moiety optionally substituted with halogen, hydroxy, alkoxy, cyano, or nitro, or the like. Some examples are illustrated below:

S—C(O)-hydrocarbyl; S—CH₂O₂C(hydrocarbyl); S—CH₃; S—C(O)-aryl

Compounds of these types can be prepared from a compound of Formula I wherein R² represents SH by methods well established in the art. For example, acylthio derivatives may be prepared by treatment with acyl halides or anhydrides and hydrocarbyloxyalkylthio derivatives may be prepared by treatment with a hydrocarbylheteroalkyl halide.

The present invention also includes the use of the compounds and compositions set forth herein for control of non-agricultural insect species, for example, dry wood termites and subterranean termites; as well as for use as pharmaceutical agents. In the field of veterinary medicine, the compounds of the present invention are expected to be effective against certain endo- and ecto-parasites, such as insects and worms, which prey on animals. Examples of such animal parasites include, without limitation, Gastrophilus spp., Stoinoxys spp., Trichodectes spp., Rhodizius spp., Ctenocephalides canis, and other species.

The following examples further illustrate the present invention, but, of course, should not be construed as in any way limiting its scope. The examples are organized to present protocols for the synthesis of the compounds of formula I of the present invention, set forth a list of such synthesized species, and set forth certain biological data indicating the efficacy of such compounds.

### EXAMPLE 1

### This Example Illustrates One Protocol for the Preparation of 3-chloro-4-pyrid-3-yl-1,2,5-thiadiazole (Compound 130)

### Step A 2-hydroxy-2-pyrid-3-yl-ethanenitrile

This compound was prepared in the manner described in Sauerberg et al. (Journal of Medicinal Chem., Vol. 35, No. 12, pp. 2274-2283 (1992)), namely, a stirred solution of 41.8 grams (0.64 mole) of potassium cyanide (available from Aldrich Chemical Company, Inc., Milwaukee, Wis.) in 175 mL of water was cooled to 5° C., and 62.5 grams (0.58 mole) of 3-pyridinecarboxaldehyde (available from Aldrich Chemical Company, Inc.) was added dropwise at a rate to maintain the reaction temperature below 5° C. Upon completion of addition, 38.5 grams (0.64 mole) of acetic acid (available from EM Sciences, Gibbstown, N.J.) was added dropwise at a rated to maintain the reaction temperature below 5° C., and the reaction mixture was then stirred at 5 to 10° C. for two hours. After this time, the reaction mixture was cooled to 5° C. and a yellow precipitate was collected by filtration under reduced pressure. The yellow precipitate was washed with cold water, yielding 78.27 grams (100% yield) of title compound. The NMR spectrum was consistent with the proposed structure.

### Step B 2-amino-2-pyrid-3-yl-ethanenitrile

Ammonium chloride (available from J. T. Baker Inc., Phillipsburg, N.J.), 113.6 grams (2.12 moles), and 52 mL (0.8 mole) of a 25% aqueous ammonium hydroxide solution (available from J. T. Baker Inc.) was taken up in 440 mL of water at ambient temperature, and then 78.2 grams (0.6 mole) of 2-hydroxy-2-pyrid-3-yl-ethanenitrile was added. Upon completion of addition, the reaction mixture was stirred at ambient temperature for about 18 hours. At the conclusion of this period, the reaction mixture was poured into a separatory funnel and extracted with several portions of methylene chloride followed by several portions of ethyl acetate. The combined extracts were dried with sodium sulfate and filtered. The filtrate was concentrated under reduced pressure, yielding 60.7 grams (78% yield) of title compound. The NMR spectrum was consistent with the proposed structure.

### Step C Compound 130

Sulfur monochloride (available from Aldrich Chemical Company, Inc.), 123.1 grams (0.91 mole) was taken up in 120 mL of N,N-dimethylformamide (DMF, available from EM Sciences, Gibbstown, N.J.). The mixture was cooled to 0° C. in an ice bath, and a solution of 60.7 grams (0.5 mole) of 2-amino-2-pyrid-3-yl-ethanenitrile in 80 mL of DMF was added dropwise at a rate to maintain the reaction temperature below 10° C. Upon completion of addition, 100 mL of methylene chloride was added. The resulting mixture was allowed to warm to ambient temperature where it stirred for about 48 hours. After this time, the reaction mixture was quenched with ice in an ice bath and then stirred for thirty minutes. At the conclusion of this period, the mixture was filtered to remove the sulfur, and the filter cake was washed thoroughly with ethyl acetate. The aqueous layer was separated from the organic layer, made basic with potassium carbonate, saturated with sodium chloride and extracted with five portions of ethyl acetate. The combined extracts were dried with magnesium sulfate and filtered. The filtrate was concentrated under reduced pressure, yielding crude product. The crude product was purified by flash chromatography, yielding 64.1 grams (76.6% yield) of Compound 130. The NMR spectrum was consistent with the proposed structure.

### EXAMPLE 2

### This Example Illustrates One Protocol for the Preparation of 3-methyl-4-pyrid-3-yl-1,2,5-thiadiazole (Compound 132)

Compound 130 (prepared in the manner of Example 1), 1.1 grams (0.006 mole), was taken up in 15 mL of tetrahydrofuran (THF, available from Aldrich Chemical Company, Inc.) at −6° C. in an ice bath containing an aqueous solution saturated with sodium chloride. Upon completion of dissolution, 2 mL (0.006 mole) of three molar methyl magnesium chloride (available from Aldrich Chemical Company, Inc.) was added during a 15 minute period. Upon completion of addition, the reaction mixture was allowed to warm to ambient temperature where it stirred for twenty minutes. At the conclusion of this period, the reaction mixture was cooled to 0° C. and 25 mL of an aqueous saturated ammonium chloride solution was slowly added. Upon completion of addition, the mixture was extracted with ethyl acetate followed by an aqueous solution saturated with sodium chloride. The combined extracts were dried with sodium sulfate and the solvent was removed under reduced pressure to yield about 1.2 grams of crude product. The crude product was purified by column chromatography on silica gel, yielding 0.7 gram of Compound 132; mp 55-57° C. The NMR spectrum was consistent with the proposed structure.

### EXAMPLE 3

### This Example Illustrates One Protocol for the Preparation of the Bromide Salt of 3-chloro-4-(1-benzylpyrid-3-yl)-1,2,5-thiadiazole (Compound 162)

A solution of 1.5 grams (0.008 mole) of Compound 130 (prepared in the manner of Example 1) and 1.2 mL of (0.01 mole) of benzyl bromide (available from Aldrich Chemical Company, Inc.) in 40 mL of acetone (available from J.T. Baker Inc.) was stirred at ambient temperature for about 18 hours. After this time, most of the solvent was removed under reduced pressure to yield a residue. To the residue was added 30 mL of diethyl ether. The mixture was allowed to settle and the liquid was decanted, yielding a residue. The residue was dried under reduced pressure, yielding 1.4 grams (54% yield) of the title compound. The NMR spectrum was consistent with the proposed structure.

### EXAMPLE 4

### This Example Illustrates One Protocol for the Preparation of 3-chloro-4-[1-benzyl(1,2,5,6-tetrahydropyrid-3-yl)]-1,2,5-thiadiazole (Compound 2)

Under a nitrogen atmosphere, a stirred solution of 1.4 grams (0.0039 mole) of Compound 162 (prepared in the manner of Example 3) in 30 mL of ethanol (EtOH, available from J.T. Baker Inc.) was cooled in an ice bath and 0.2 gram (0.004 mole) of sodium borohydride (available from Aldrich Chemical Company, Inc.) was added. Upon completion of addition, the reaction mixture was stirred for twenty minutes. At the conclusion of this period, the reaction mixture was allowed to warm to ambient temperature where it stirred for three hours. After this time, 40 mL of water was added and the resulting mixture was extracted with two 50 mL portions of methylene chloride. The combined extracts were dried with sodium sulfate and the solvent was removed, yielding 1.2 grams of crude product. The crude product was purified by column chromatography on silica gel, yielding 0.5 grams (38% yield) of 95% pure title compound. The NMR spectrum was consistent with the proposed structure.

### EXAMPLE 5

### This Example Illustrates One Protocol for the Preparation of 3-fluoro-4-pyrid-3-yl-1,2,5-thiadiazole (Compound 131)

Compound 130 (prepared in the manner of Example 1), 0.6 gram (0.003 mole), was taken up in 3 mL of N,N-dimethylacetamide (DMAC, available from Aldrich Chemical Company). Upon completion of dissolution, 0.2 gram (0.004 mole) of potassium fluoride (available from Aldrich Chemical Company, Inc.) and 0.3 gram (0.003 mole) of tetramethylammonium chloride (available from Aldrich Chemical Company, Inc.) was added. Upon completion of addition, the reaction mixture was heated to 140° C. where it stirred 2.5 hours. At the conclusion of this period, the reaction mixture was analyzed by gas chromatography (GC), which indicated the reaction was incomplete. An additional 0.1 gram (0.0005 mole) of potassium fluoride was added and the reaction mixture was heated at 140° C. for an additional 1.5 hours. After this time, the reaction mixture was again analyzed by GC, which again indicated that the reaction was incomplete. An additional 0.06 gram (0.0003 mole) of potassium fluoride was added and the reaction mixture was heated at 140° C. for an additional hour. The reaction mixture was analyzed for a third time by GC, which indicated the reaction was incomplete. An additional 0.05 gram (0.0003 mole) of potassium fluoride was added and the reaction mixture was heated at 140° C. for an additional hour. At the conclusion of this period, the reaction mixture was diluted with 25 mL of ethyl acetate and filter through glass wool. The filtrate was combined with the filtrate from a similar experiment. The solvent was removed under reduced pressure at 40° C. Any unreacted DMAC was removed under reduced pressure, yielding 1.86 grams of crude product. The crude product was taken up in ethyl acetate and purified by column chromatography on silica gel, yielding 0.7 gram (64% yield) of Compound 131. The NMR spectrum was consistent with the proposed structure.

### EXAMPLE 6

### This Example Illustrates One Protocol for the Preparation of 3-fluoro-4-(1-methyl-1,2,5,6-tetrahydropyrid-3-yl)-1,2,5-thiadiazole (Compound 23)

### Step A Iodide Salt of 3-fluoro-4-(1-methylpyrid-3-yl)-1,2,5-thiadiazole

This compound was prepared in the manner of Example 3, using 0.6 gram (0.003 mole) of Compound 131 and 0.4 mL of methyl iodide (available from Aldrich Chemical Company, Inc.) in 10 mL of acetone. The yield of the title compound was 0.8 gram. The NMR spectrum was consistent with the proposed structure.

### Step B Compound 23

The iodide salt of 3-fluoro-4-(1-methylpyrid-3-yl)-1,2,5-thiadiazole, 0.4 gram (0.001 mole), was taken up in 10 mL of methanol (MeOH, available from J.T. Baker Inc.) and about 8 mL of TVF was added to effect dissolution. The solution was cooled to 0° C. in an ice bath and 0.07 gram (0.002 mole) of crushed sodium borohydride was added during a 12 to 15 minute period. Upon completion of addition, the reaction mixture was stirred at 0° C. for one hour. After this time, the reaction mixture was poured into 15 mL of ice and most of the organic solvents were removed under a nitrogen atmosphere. The remaining aqueous mixture was extracted with two 25 mL portions of ethyl acetate. The combined extracts were dried with sodium sulfate and concentrated under reduced pressure to yield the crude product. The crude product was purified by column chromatography on silica gel, yielding 0.09 to 0.1 gram of Compound 23. The NMR spectrum was consistent with the proposed structure.

### EXAMPLE 7

### This Example Illustrates One Protocol for the Preparation of 3-pyrid-3-yl-1,2,5-thiadiazole (Compound 129)

To a stirred solution of 0.3 gram (0.002 mole) of Compound 130 (prepared in the manner of Example 1) in 6 mL of MeOH was added 0.3 gram (0.005 mole) of sodium thiomethoxide (available from Fluka Chemical Corp., Ronkonkoma, N.Y.). Upon completion of addition, the reaction mixture was stirred at ambient temperature for about 18 hours. After this time, the reaction mixture was refluxed for two hours. Upon completion of this period, the reaction mixture was analyzed by thin layer chromatography (TLC), which indicated that the reaction was complete. The reaction mixture was poured into water and extracted with three portions ethyl acetate. The combined extracts were dried with magnesium sulfate and filtered. The filtrate was concentrated under reduced pressure, yielding 0.17 gram (68% yield) of Compound 129. The NMR spectrum was consistent with the proposed structure.

### EXAMPLE 8

### This Example Illustrates One Protocol for the Preparation of 3-[1-methyl(1,2,5,6-tetrahydropyrid-3-yl)]-1,2,5-thiadiazole (Compound 4)

### Step A Iodide Salt of 4-(1-methylpyrid-3-yl)-1,2,5-thiadiazole

This compound was prepared in the manner of Example 3, using 0.14 gram (0.0009 mole) of Compound 129 and 0.3 mL of methyl iodide in 5 mL of acetone. The yield of the title compound was 0.2 gram. The NMR spectrum was consistent with the proposed structure.

### Step B Compound 4

This compound was prepared in the manner of Example 4, using 0.2 gram (0.0005 mole) of the iodide salt of 4-(1-methylpyrid-3-yl)-1,2,5-thiadiazole and 0.06 gram (0.002 mole) of sodium borohydride in 20 mL of ethanol. The NMR spectrum was consistent with the proposed structure.

### EXAMPLE 9

### This Example Illustrates One Protocol for the Preparation of 3-chloro-4-(3-chloroquinuclidin-3-yl)-1,2,5-thiadiazole (Compound 103)

### Step A Hydrochloride Salt of ethyl 2-cyano-2-quinuclidin-3-ylideneacetate

This compound was prepared in the manner described in Olesen et al. (Eur. J. Med. Chem., 31, pp. 221-230 (1996)), namely, to a stirred solution of 26.9 grams (0.2 mole) of 3-quinuclidinone hydrochloride (available from Aldrich Chemical Company, Inc.) and 35.4 mL (0.03 mole) of ethyl cyanoacetate (available from Aldrich Chemical Company) was added 46.4 mL of triethylamine (TEA, available from J.T. Baker Inc.). Upon completion of addition, the reaction mixture was heated to 80° C. where it stirred for two hours. At the conclusion of this period, the reaction mixture was diluted with water and extracted with three portions of ethyl acetate. The extracts were combined, dried with magnesium sulfate and filtered. The filtrate was concentrated under reduced pressure, yielding 39.8 grams of reddish viscous oil. The reddish viscous oil was diluted with diethyl ether and a 1.0 M solution of hydrogen chloride in diethyl ether was added. The resulting mixture was cooled to ambient temperature where it was allowed to stand for about 18 hours. After this time, the mixture was scratched with a spatula several times to yield a pinkish granular solid. The solid was filtered and dried under reduced pressure, yielding 41.91 grams (98.1% yield) of title compound; mp 192-194° C. The NMR spectrum was consistent with the proposed structure.

### Step B Hydrochloride Salt of ethyl 2-cyano-2-quinuclidin-3-ylacetate

Under a nitrogen atmosphere, to 0.4 gram of 10% palladium on carbon was added a solution of 41.9 grams (0.02 mole) of the hydrochloride salt of ethyl 2-cyano-2-quinuclidin-3-ylideneacetate bottle in 225 mL of EtOH. Upon completion of addition, the reaction mixture was hydrogenated in a Parr hydrogenator. When it was noticed that the hydrogenation was proceeding slowly, an additional 0.3 gram of 5% palladium on carbon was added to the reaction mixture to drive the hydrogenation to completion. Upon completion of the hydrogenation, the reaction mixture was filtered, and the filtrate was concentrated under reduced pressure, yielding 42 grams (99% yield) of title compound. The NMR spectrum was consistent with the proposed structure.

### Step C Compound 103

This compound was prepared hi the manner described in Olesen et al. (Eur. J. Med. Chem., 31, pp. 221-230 (1996)), namely, under a nitrogen atmosphere, 8.7 grams (0.4 mole) of sodium (available from Aldrich Chemical Company, Inc.) was added in portions to 200 mL of a 1:1 mixture of MeOH and EtOH. To the resulting mixture was added 42.0 grams (0.2 mole) of the hydrochloride salt of ethyl 2-cyano-2-quinuclidin-3-ylacetate. Upon completion of addition, the resulting solution was stirred for thirty minutes. After this time, the mixture was cooled to 0-5° C. in an ice bath and 33 mL of isoamyl nitrite (available from Aldrich Chemical Company, Inc.) was added dropwise at a rate to maintain the reaction temperature below 10° C. Upon completion of addition, the reaction mixture was concentrated under reduced pressure and toluene was added. The resulting mixture was again concentrated under reduced pressure, yielding a residue. The residue was taken up in DMF. The resulting solution was added dropwise to a solution of 76.6 grams (0.6 mole) of sulfur monochloride in 80 mL of DMF at rate to maintain the reaction temperature at or below 0° C. Upon completion of addition, the reaction mixture was allowed to warm to ambient temperature where it stirred for about 48 hours. At the conclusion of this period, 100 mL of water was carefully added. The reaction mixture was warmed to 70° C. and filtered. The filtrate was diluted with water and made basic with potassium carbonate. The basic mixture was extracted with three portions of ethyl acetate. The combined extracts were dried with magnesium sulfate and filtered. The filtrate was concentrated under reduced pressure, yielding a dark reddish black viscous oil. The residue was purified by flash chromatography, yielding 10.0 grams of Compound 103; mp 93-95° C. The NMR spectrum was consistent with the proposed structure.

### EXAMPLE 10

### This Example Illustrates One Protocol for the Preparation of 3-chloro-4-quinuclidin-3-yl-1,2,5-thiadiazole (Compound 102)

Under a nitrogen atmosphere, a mixture of 0.3 gram of 10% palladium on carbon, 0.2 gram of 5% palladium on carbon, 7.4 grams (0.03 mole) of Compound 103, 80 mL of ethyl acetate, 30 mL of TEA, and 30 mL of methylene chloride (available from J.T. Baker Inc.) was hydrogenated in a Parr hydrogenator. When it was noticed that the hydrogenation had stalled, an additional 4.0 grams of 10% palladium on carbon, 0.3 gram of 5% palladium on carbon and 1.0 gram (0.004 mole) of Compound 106 were added. Upon completion of addition, the reaction mixture was hydrogenated for about 48 hours. After this time, the reaction mixture was analyzed by GC and TLC, which indicated that the hydrogenation was complete. The reaction mixture was filtered. The filtrate was concentrated under reduced pressure to yield a residue. The residue was taken up in water, made basic with potassium carbonate, and extracted with three portions of methylene chloride. The extracts were combined, dried with magnesium sulfate and filtered. The filtrate was concentrated under reduced pressure, yielding 6.0 grams (92.9% yield) of Compound 102. The NMR spectrum was consistent with the proposed structure.

### EXAMPLE 11

### This Example Illustrates One Protocol for the Preparation of 3-butoxy-4-quinuclidin-3-yl-1,2,5-thiadiazole (Compound 110)

Normal (n)-Butanol (available from J.T. Baker Inc.), 5 mL, was chilled in an ice bath, and 0.1 gram (0.025 mole) of 60% sodium hydride in oil (available from Aldrich Chemical Company, Inc.) followed by 0.3 gram (0.001 mole) of Compound 102 was added. Upon completion of addition, the reaction mixture was allowed to warm to ambient temperature where it stirred for about 48 hours. At the conclusion of this period, the reaction mixture was heated to 60° C. where it stirred for four hours. After this time, the reaction mixture was analyzed by GC, which indicated that none of the starting material was present. The solvent was removed under reduced pressure, yielding a residue. The residue was taken up in ethyl acetate and washed with an aqueous concentrated sodium chloride solution. The organic layer was separated and the solvent was removed under reduced pressure, yielding an orange oil. The orange oil was purified by column chromatography on silica gel, yielding Compound 110. The NMR spectrum was consistent with the proposed structure.

It is well known to one of ordinary skill in the art that the compounds of formula I of the present invention can contain optically-active and racemic forms. It is also well known in the art that the compounds of formula II may contain stereoisomeric forms and/or exhibit polymorphism. It is to be understood that the present invention encompasses any racemic, optically-active, polymorphic or stereoisomeric form, or mixtures thereof. It should be noted that it is well known in the art how to prepare optically-active forms, for example by resolution of a racemic mixture or by synthesis from optically-active starting materials.

The following table sets forth some compounds of formula I:

TABLE 1
Pesticidal 1,2,5-Thiadiazole Derivatives

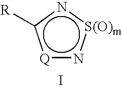

where R is a azabicyclic selected from the following structures:

| | | |
|---|---|---|
| 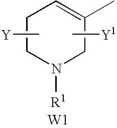 | 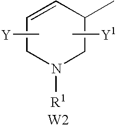 | 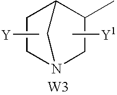 |
| 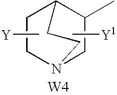 | 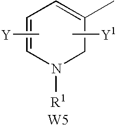 | 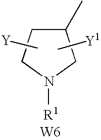 |
| 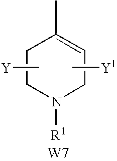 | 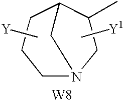 | 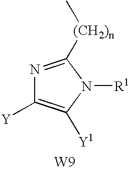 |
| 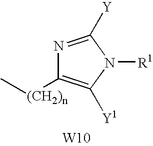 | 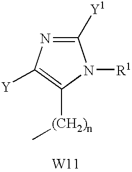 | 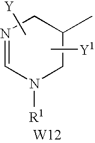 |
| 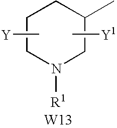 | 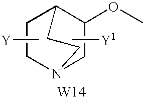 | 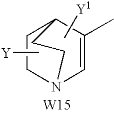 |
| 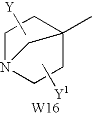 | 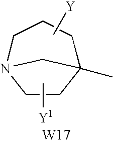 | 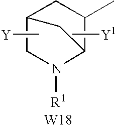 |
| 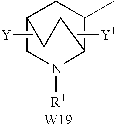 | 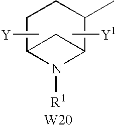 | 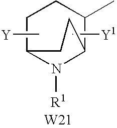 |
| 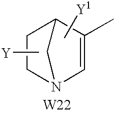 | 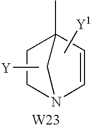 | 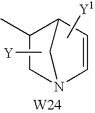 |
| 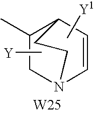 | 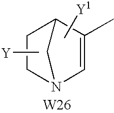 | 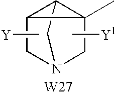 |
| 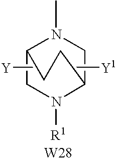 | | |

and where

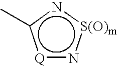

is a 1,2,5-thiadiazole where Q is CR² or C═R⁴, where the
1,2,5-thiadiazole is selected from

| | |
|---|---|
| 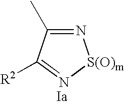 | 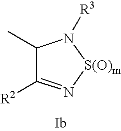 |
| a 1,2,5-thiadiazol-3-yl | a 1,2,5-thiadiazolin-3-yl |
| 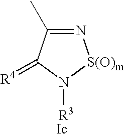 | 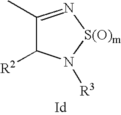 |
| a 1,2,5-thiadiazolin-3-R⁴-4-yl | a 1,2,5-thiadiazolin-4- |
| | yl |

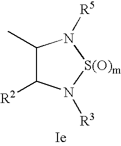

a 1,2,5-thiadiazolidin-3-yl

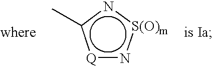

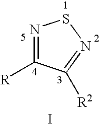

where m is 0:

| Cmpd. | | | | | |
|---|---|---|---|---|---|
| No. | R | R¹ | R² | Y | Y¹ |
| 1 | W1 | H | Cl | H | H |
| 2 | W1 | —CH₂C₆H₅ | Cl | H | H |
| 3 | W1 | —C(O)OC₂H₅ | Cl | H | H |
| 4 | W1 | —CH₃ | H | H | H |
| 5 | W1 | —CH₃ | H | 2-Cl | H |
| 6 | W1 | —CH₃ | H | 2-F | H |
| 7 | W1 | —CH₃ | H | 2-CH₃ | H |
| 8 | W1 | —CH₃ | H | 4-Cl | H |
| 9 | W1 | —CH₃ | H | 4-F | H |
| 10 | W1 | —CH₃ | H | 4-CH₃ | H |
| 11 | W1 | —CH₃ | H | 6-Cl | H |
| 12 | W1 | —CH₃ | H | 6-F | H |
| 13 | W1 | —CH₃ | H | 6-CH₃ | H |
| 14 | W1 | —CH₃ | H | 2-Cl | 2-Cl |
| 15 | W1 | —CH₃ | H | 2-F | 2-F |
| 16 | W1 | —CH₃ | H | 2-CH₃ | 2-CH₃ |
| 17 | W1 | —CH₃ | H | 6-Cl | 6-Cl |
| 18 | W1 | —CH₃ | H | 6-F | 6-F |
| 19 | W1 | —CH₃ | H | 6-CH₃ | 6-CH₃ |
| 20 | W1 | —C₂H₅ | H | H | H |
| 21 | W1 | —CH₂OCH₃ | H | H | H |
| 22 | W1 | —CH₃ | Cl | H | H |
| 23 | W1 | —CH₃ | F | H | H |
| 24 | W1 | —CH₃ | F | 2-Cl | H |
| 25 | W1 | —CH₃ | F | 2-F | H |
| 26 | W1 | —CH₃ | F | 2-CH₃ | H |
| 27 | W1 | —CH₃ | F | 4-Cl | H |
| 28 | W1 | —CH₃ | F | 4-F | H |
| 29 | W1 | —CH₃ | F | 4-CH₃ | H |
| 30 | W1 | —CH₃ | F | 6-Cl | H |
| 31 | W1 | —CH₃ | F | 6-F | H |
| 32 | W1 | —CH₃ | F | 6-CH₃ | H |
| 33 | W1 | —CH₃ | F | 2-Cl | 2-Cl |
| 34 | W1 | —CH₃ | F | 2-F | 2-F |
| 35 | W1 | —CH₃ | F | 2-CH₃ | 2-CH₃ |
| 36 | W1 | —CH₃ | F | 6-Cl | 6-Cl |
| 37 | W1 | —CH₃ | F | 6-F | 6-F |
| 38 | W1 | —CH₃ | F | 6-CH₃ | 6-CH₃ |
| 39 | W1 | —CH₃ | —CH₃ | H | H |
| 40 | W1 | —CH₃ | —CH₃ | 2-Cl | H |
| 41 | W1 | —CH₃ | —CH₃ | 2-F | H |
| 42 | W1 | —CH₃ | —CH₃ | 2-CH₃ | H |
| 43 | W1 | —CH₃ | —CH₃ | 4-Cl | H |
| 44 | W1 | —CH₃ | —CH₃ | 4-F | H |
| 45 | W1 | —CH₃ | —CH₃ | 4-CH₃ | H |
| 46 | W1 | —CH₃ | —CH₃ | 6-Cl | H |
| 47 | W1 | —CH₃ | —CH₃ | 6-F | H |
| 48 | W1 | —CH₃ | —CH₃ | 6-CH₃ | H |
| 49 | W1 | —CH₃ | —CH₃ | 2-Cl | 2-Cl |
| 50 | W1 | —CH₃ | —CH₃ | 2-F | 2-F |
| 51 | W1 | —CH₃ | —CH₃ | 2-CH₃ | 2-CH₃ |
| 52 | W1 | —CH₃ | —CH₃ | 6-Cl | 6-Cl |
| 53 | W1 | —CH₃ | —CH₃ | 6-F | 6-F |
| 54 | W1 | —CH₃ | —CH₃ | 6-CH₃ | 6-CH₃ |
| 55 | W1 | —CH₃ | —CH₂CH₂C₆H₅ | H | H |
| 56 | W1 | —CH₃ | —OCH₃ | H | H |
| 57¹ | W1 | —CH₃ | —OCH₃ | H | H |
| 58 | W1 | —CH₃ | —OC₂H₅ | H | H |
| 59 | W1 | —CH₃ | —OC₃H₇ | H | H |
| 60 | W1 | —CH₃ | —OC₄H₉ | H | H |
| 61 | W1 | —CH₃ | —OC₅H₁₁ | H | H |
| 62 | W1 | —CH₃ | —OC₆H₁₃ | H | H |
| 63 | W1 | —CH₃ | 4-FPhO— | H | H |
| 64 | W1 | —CH₃ | —OCH₂CH═CH₂ | H | H |
| 65¹ | W1 | —CH₃ | —OCH₂CH═CH₂ | H | H |
| 66 | W1 | —CH₃ | —OCH₂C≡CH | H | H |
| 67 | W1 | —CH₃ | —OCH₂C≡CCH₃ | H | H |
| 68 | W1 | —CH₃ | —OCH₂CH₂C≡CH | H | H |
| 69 | W1 | —CH₃ | —SCH₃ | H | H |
| 70 | W1 | —CH₃ | —SC₂H₅ | H | H |
| 71 | W1 | —CH₃ | —SC₃H₇ | H | H |
| 72 | W1 | —CH₃ | —SC₄H₉ | H | H |
| 73 | W1 | —CH₃ | —SC₅H₁₁ | H | H |
| 74 | W1 | —CH₃ | —SC₅H₁₀CN | H | H |
| 75 | W1 | —CH₃ | —SC₆H₁₃ | H | H |
| 76 | W1 | —CH₃ | —SC₆H₁₂CN | H | H |
| 77 | W1 | —CH₃ | —SCH₂CH═CH₂ | H | H |
| 78 | W1 | —CH₃ | —SCH₂C≡CH | H | H |
| 79 | W2 | —CH₃ | —C(O)OC₄H₉ | H | H |
| 80 | W3 | — | H | H | H |
| 81 | W3 | — | H | 2-Cl | H |
| 82 | W3 | — | H | 2-F | H |
| 83 | W3 | — | H | 2-CH₃ | H |
| 84 | W3 | — | H | 4-Cl | H |
| 85 | W3 | — | H | 4-F | H |
| 86 | W3 | — | H | 4-CH₃ | H |
| 87 | W3 | — | H | 6-Cl | H |
| 88 | W3 | — | H | 6-F | H |
| 89 | W3 | — | H | 6-CH₃ | H |
| 90 | W3 | — | H | 2-Cl | 2-Cl |
| 91 | W3 | — | H | 2-F | 2-F |
| 92 | W3 | — | H | 2-CH₃ | 2-CH₃ |
| 93 | W3 | — | H | 6-Cl | 6-Cl |
| 94 | W3 | — | H | 6-F | 6-F |
| 95 | W3 | — | H | 6-CH₃ | 6-CH₃ |
| 96 | W3 | — | Cl | H | H |
| 97 | W3 | — | F | H | H |
| 98 | W3 | — | CH3 | H | H |
| 99 | W3 | — | —OCH₂C≡CH | H | H |
| 100 | W4 | — | H | H | H |
| 101 | W4 | — | F | H | H |
| 102 | W4 | — | Cl | H | H |
| 103 | W4 | — | Cl | 3-Cl | H |
| 104² | W4 | — | Cl | 3-Cl | H |
| 105 | W4 | — | Cl | 2-Cl | 2-Cl |
| 106 | W4 | — | Cl | 6-CH₃ | 6-CH₃ |
| 107 | W4 | — | —OCH₃ | H | H |
| 108 | W4 | — | —OC₂H₅ | H | H |
| 109 | W4 | — | —OC₃H₇ | H | H |
| 110 | W4 | — | —OC₄H₉ | H | H |
| 111 | W4 | — | —OC₅H₁₁ | H | H |
| 112 | W4 | — | —OC₆H₁₃ | H | H |
| 113 | W4 | — | —OCH₂CH═CH₂ | H | H |
| 114 | W4 | — | —OCH₂C≡CH | H | H |
| 115 | W4 | — | —OCH₂C≡CCH₃ | H | H |
| 116 | W4 | — | —OCH₂CH₂C≡CH | H | H |
| 117 | W4 | — | —SCH₃ | H | H |
| 118 | W4 | — | —SC₂H₅ | H | H |
| 119 | W4 | — | —SC₃H₇ | H | H |
| 120 | W4 | — | —SC₄H₉ | H | H |
| 121 | W4 | — | —SC₅H₁₁ | H | H |
| 122 | W4 | — | —SC₅H₁₀CN | H | H |
| 123 | W4 | — | —SC₆H₁₃ | H | H |
| 124 | W4 | — | —SC₆H₁₂CN | H | H |
| 125 | W4 | — | —SCH₂CH═CH₂ | H | H |
| 126 | W4 | — | —SCH₂C≡CH | H | H |
| 127 | W4 | — | —SCH₂C≡CCH₃ | H | H |
| 128 | W4 | — | —SCH₂CH₂C≡CH | H | H |
| 129 | W5 | H | H | H | H |
| 130 | W5 | H | Cl | H | H |
| 131 | W5 | H | F | H | H |
| 132 | W5 | H | —CH₃ | H | H |
| 133 | W5 | H | —C₂H₅ | H | H |
| 134 | W5 | H | —C₃H₇ | H | H |
| 135 | W5 | H | —C₄H₉ | H | H |
| 136 | W5 | H | —C₅H₁₁ | H | H |
| 137 | W5 | H | —SC₆H₁₃ | H | H |
| 138 | WS | H | —OCH₃ | H | H |
| 139 | W5 | H | —OC₂H₅ | H | H |
| 140 | W5 | H | —OC₃H₇ | H | H |
| 141³ | W5 | —CH₃ | —OC₃H₇ | H | H |
| 142 | W5 | H | —OC₄H₉ | H | H |
| 143 | W5 | H | —OC₅H₁₁ | H | H |
| 144 | W5 | H | —OC₆H₁₃ | H | H |
| 145 | W5 | H | —OCH₂CH═CH₂ | H | H |
| 146³ | W5 | —CH₃ | —OCH₂CH═CH₂ | H | H |
| 147 | W5 | H | —OCH₂C≡CCH₃ | H | H |
| 148 | W5 | H | —OCH₂CH₂C≡CH | H | H |
| 149 | W5 | H | —SCH₃ | H | H |
| 150 | W5 | H | —SC₂H₅ | H | H |
| 151 | W5 | H | —SC₃H₇ | H | H |
| 152 | W5 | H | —SC₄H₉ | H | H |
| 153 | W5 | H | —SC₅H₁₁ | H | H |
| 154 | W5 | H | —SC₅H₁₀CN | H | H |
| 155 | W5 | H | —SC₆H₁₃ | H | H |
| 156 | W5 | H | —SC₆H₁₂CN | H | H |
| 157 | W5 | H | —SCH₂CH═CH₂ | H | H |
| 158 | W5 | H | —SCH₂C≡CH | H | H |
| 159 | W5 | H | —SCH₂C≡CCH₃ | H | H |
| 160 | W5 | H | —SCH₂CH₂C≡CH | H | H |
| 161⁴ | W5 | —C(O)OC₂H₅ | Cl | H | H |
| 162⁵ | W5 | —CH₂C₆H₅ | Cl | H | H |
| 163 | W6 | H | H | H | H |
| 164 | W6 | H | Cl | H | H |
| 165 | W6 | H | F | H | H |
| 166 | W6 | H | —CH₃ | H | H |
| 167 | W6 | H | —OCH₂C≡CCH₃ | H | H |
| 168 | W6 | —CH₃ | H | H | H |
| 169 | W6 | —CH₃ | Cl | H | H |
| 170 | W6 | —CH₃ | F | H | H |
| 171 | W6 | —CH₃ | —CH₃ | H | H |
| 172 | W6 | —CH₃ | —OCH₂C≡CCH₃ | H | H |
| 173 | W7 | H | H | H | H |
| 174 | W7 | H | Cl | H | H |
| 175 | W7 | H | Cl | 4-Cl | H |
| 1776 | W7 | H | F | H | H |
| 177 | W7 | H | —CH₃ | H | H |
| 178 | W7 | H | —OCH₂C≡CH | H | H |
| 179 | W7 | —CH₃ | H | H | H |
| 180 | W7 | —CH₃ | Cl | H | H |
| 181 | W7 | —CH₃ | Cl | H | H |
| 182 | W7 | —CH₃ | F | H | H |
| 183 | W7 | —CH₃ | —CH₃ | H | H |
| 184 | W7 | —CH₃ | —OCH₂C≡CH | H | H |
| 185 | W7 | —CH₃ | —CH₃ | 2-Cl | H |
| 186 | W7 | —CH₃ | —CH₃ | 2-F | H |
| 187 | W7 | —CH₃ | —CH₃ | 2-CH₃ | H |
| 188 | W7 | —CH₃ | —CH₃ | 4-Cl | H |
| 189 | W7 | —CH₃ | —CH₃ | 4-F | H |
| 190 | W7 | —CH₃ | —CH₃ | 4-CH₃ | H |
| 191 | W7 | —CH₃ | —CH₃ | 6-Cl | H |
| 192 | W7 | —CH₃ | —CH₃ | 6-F | H |
| 193 | W7 | —CH₃ | —CH₃ | 6-CH₃ | H |
| 194 | W7 | —CH₃ | —CH₃ | 2-Cl | 2-Cl |
| 195 | W7 | —CH₃ | —CH₃ | 2-F | 2-F |
| 196 | W7 | —CH₃ | —CH₃ | 2-CH₃ | 2-CH₃ |
| 197 | W7 | —CH₃ | —CH₃ | 6-Cl | 6-Cl |
| 198 | W7 | —CH₃ | —CH₃ | 6-F | 6-F |
| 199 | W7 | —CH₃ | —CH₃ | 6-CH₃ | 6-CH₃ |
| 200 | W8 | — | H | H | H |
| 201 | W8 | — | Cl | H | H |
| 202 | W8 | — | F | H | H |
| 203 | W8 | — | —CH₃ | H | H |
| 204 | W8 | — | —OCH₂C≡CH | H | H |

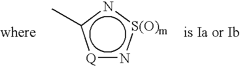

| | |
|---|---|
| 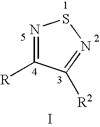 | 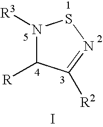 |
| Derived from Ia, where m is 0 | Derived from Ib, where m is 0 |

| Cmpd. | | | | | | |
|---|---|---|---|---|---|---|
| No | Formula | R | R² | R³ | R¹ | n |
| 205 | Ia | W9 | H | — | H | 0 |
| 206 | Ia | W9 | Cl | — | H | 0 |
| 207 | Ia | W9 | F | — | H | 0 |
| 208 | Ia | W9 | —CH₃ | — | H | 0 |
| 209 | Ia | W9 | —C₂H₅ | — | H | 0 |
| 210 | Ia | W9 | —OCH₃ | — | H | 0 |
| 211 | Ia | W9 | —CH₂OCH | — | H | 0 |
| 212 | Ia | W9 | —OCH₂C≡CH | — | H | 0 |
| 213 | Ia | W9 | H | — | H | 1 |
| 214 | Ia | W9 | Cl | — | H | 1 |
| 215 | Ia | W9 | F | — | H | 1 |
| 216 | Ia | W9 | —CH₃ | — | H | 1 |
| 217 | Ia | W9 | —C₂H₅ | — | H | 1 |
| 218 | Ia | W9 | —OCH₃ | — | H | 1 |
| 219 | Ia | W9 | —CH₂OCH | — | H | 1 |
| 220 | Ia | W9 | —OCH₂C≡CH | — | H | 1 |
| 221 | Ia | W9 | H | — | —CH₃ | 0 |
| 222 | Ia | W9 | Cl | — | —CH₃ | 0 |
| 223 | Ia | W9 | F | — | —CH₃ | 0 |
| 224 | Ia | W9 | —CH₃ | — | —CH₃ | 0 |
| 225 | Ia | W9 | —C₂H₅ | — | —CH₃ | 0 |
| 226 | Ia | W9 | —OCH₃ | — | —CH₃ | 0 |
| 227 | Ia | W9 | —CH₂OCH | — | —CH₃ | 0 |
| 228 | Ia | W9 | —OCH₂C≡CH | — | —CH₃ | 0 |
| 229 | Ib | W9 | H | —CH₂CH₂O— | | 0 |
| 230 | Ib | W9 | H | H | —CH₃ | 1 |
| 231 | Ia | W9 | Cl | — | —CH₃ | 1 |
| 232 | Ia | W9 | F | — | —CH₃ | 1 |
| 233 | Ia | W9 | —CH₃ | — | —CH₃ | 1 |
| 234 | Ia | W9 | —C₂H₅ | — | —CH₃ | 1 |
| 235 | Ia | W9 | —OCH₃ | — | —CH₃ | 1 |
| 236 | Ia | W9 | —CH₂OCH | — | —CH₃ | 1 |
| 237 | Ia | W9 | —OCH₂C≡CH | — | —CH₃ | 1 |
| 238 | Ia | W9 | H | — | —CH₃ | 2 |
| 239 | Ia | W9 | Cl | — | —CH₃ | 2 |
| 240 | Ia | W9 | F | — | —CH₃ | 2 |
| 241 | Ia | W9 | —CH₃ | — | —CH₃ | 2 |
| 242 | Ia | W9 | —C₂H₅ | — | —CH₃ | 2 |
| 243 | Ia | W9 | —OCH₃ | — | —CH₃ | 2 |
| 244 | Ia | W9 | —CH₂OCH | — | —CH₃ | 2 |
| 245 | Ia | W9 | —OCH₂C≡CH | — | —CH₃ | 2 |
| 246 | Ia | W10 | H | — | —CH₃ | 0 |
| 247 | Ia | W10 | Cl | — | —CH₃ | 0 |
| 248 | Ia | W10 | F | — | —CH₃ | 0 |
| 249 | Ia | W10 | —CH₃ | — | —CH₃ | 0 |
| 250 | Ia | W10 | —C₂H₅ | — | —CH₃ | 0 |
| 251 | Ia | W10 | —OCH₃ | — | —CH₃ | 0 |
| 252 | Ia | W10 | —CH₂OCH | — | —CH₃ | 0 |
| 253 | Ia | W10 | —OCH₂C≡CH | — | —CH₃ | 0 |
| 254 | Ib | W10 | H | —CH₂CH₂O— | | 0 |
| 255 | Ib | W10 | H | —CH₃ | —CH₃ | 1 |
| 256 | Ia | W10 | Cl | — | —CH₃ | 1 |
| 257 | Ia | W10 | F | — | —CH₃ | 1 |
| 258 | Ia | W10 | —CH₃ | — | —CH₃ | 1 |
| 259 | Ia | W10 | —C₂H₅ | — | —CH₃ | 1 |
| 260 | Ia | W10 | —OCH₃ | — | —CH₃ | 1 |
| 261 | Ia | W10 | —CH₂OCH | — | —CH₃ | 1 |
| 262 | Ia | W10 | —OCH₂C≡CH | — | —CH₃ | 1 |
| 263 | Ia | W10 | H | — | —CH₃ | 2 |
| 264 | Ia | W10 | Cl | — | —CH₃ | 2 |
| 265 | Ia | W10 | F | — | —CH₃ | 2 |
| 266 | Ia | W10 | —CH₃ | — | —CH₃ | 2 |
| 267 | Ia | W10 | —C₂H₅ | — | —CH₃ | 2 |
| 268 | Ia | W10 | —OCH₃ | — | —CH₃ | 2 |
| 269 | Ia | W10 | —CH₂OCH | — | —CH₃ | 2 |
| 270 | Ia | W10 | —OCH₂C≡CH | — | —CH₃ | 2 |
| 271 | Ia | W11 | H | — | —CH₃ | 0 |
| 272 | Ia | W11 | Cl | — | —CH₃ | 0 |
| 273 | Ia | W11 | F | — | —CH₃ | 0 |
| 274 | Ia | W11 | —CH₃ | — | —CH₃ | 0 |
| 275 | Ia | W11 | —C₂H₅ | — | —CH₃ | 0 |
| 276 | Ia | W11 | —OCH₃ | — | —CH₃ | 0 |
| 277 | Ia | W11 | —CH₂OCH | — | —CH₃ | 0 |
| 278 | Ia | W11 | —OCH₂C≡CH | — | —CH₃ | 0 |
| 279 | Ib | W11 | H | —CH₂CH₂O— | | 0 |
| 280 | Ib | W11 | H | —NH₂ | —CH₃ | 0 |
| 281 | Ia | W11 | Cl | — | —CH₃ | 1 |
| 282 | Ia | W11 | F | — | —CH₃ | 1 |
| 283 | Ia | W11 | —CH₃ | — | —CH₃ | 1 |
| 284 | Ia | W11 | —C₂H₅ | — | —CH₃ | 1 |
| 285 | Ia | W11 | —OCH₃ | — | —CH₃ | 1 |
| 286 | Ia | W11 | —CH₂OCH | — | —CH₃ | 1 |
| 287 | Ia | W11 | —OCH₂C≡CH | — | —CH₃ | 1 |
| 288 | Ia | W11 | H | — | —CH₃ | 2 |
| 289 | Ia | W11 | Cl | — | —CH₃ | 2 |
| 290 | Ia | W11 | F | — | —CH₃ | 2 |
| 291 | Ia | W11 | —CH₃ | — | —CH₃ | 2 |
| 292 | Ia | W11 | —C₂H₅ | — | —CH₃ | 2 |
| 293 | Ia | W11 | —OCH₃ | — | —CH₃ | 2 |
| 294 | Ia | W11 | —CH₂OCH | — | —CH₃ | 2 |
| 295 | Ia | W11 | —OCH₂C≡CH | — | —CH₃ | 2 |

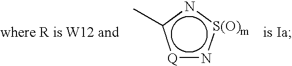

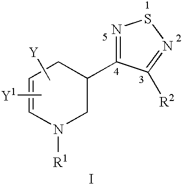

where Y and Y¹ are hydrogen, and m is 0:

| Cmpd. No. | R¹ | R² |
|---|---|---|
| 296 | H | H |
| 297 | H | —CH₃ |
| 298 | H | —C₂H₅ |
| 299 | H | —OCH₃ |
| 300 | H | —CH₂OCH |
| 301 | H | —OCH₂C≡CH |
| 302 | H | —C(O)OC₄H₉ |
| 303 | Cl | H |
| 304 | Cl | —CH₃ |
| 305 | Cl | —C₂H₅ |
| 306 | Cl | —OCH₃ |
| 307 | Cl | —CH₂OCH |
| 308 | Cl | —OCH₂C≡CH |
| 309 | Cl | —C(O)OC₄H₉ |
| 310 | F | H |
| 311 | F | —CH₃ |
| 312 | F | —C₂H₅ |
| 313 | F | —OCH₃ |
| 314 | F | —CH₂OCH |
| 315 | F | —OCH₂C≡CH |
| 316 | F | —C(O)OC₄H₉ |
| 317 | —CH₃ | H |
| 318 | —CH₃ | —CH₃ |
| 319 | —CH₃ | —C₂H₅ |
| 320 | —CH₃ | —OCH₃ |
| 321 | —CH₃ | —CH₂OCH |
| 322 | —CH₃ | —OCH₂C≡CH |
| 323 | —CH₃ | —C(O)OC₄H₉ |
| 324 | —OCH₃ | H |
| 325 | —OCH₃ | —CH₃ |
| 326 | —OCH₃ | —C₂H₅ |
| 327 | —OCH₃ | —OCH₃ |
| 328 | —OCH₃ | —CH₂OCH |
| 329 | —OCH₃ | —OCH₂C≡CH |
| 330 | —OCH₃ | —C(O)OC₄H₉ |
| 331 | —CH₂OCH | H |
| 332 | —CH₂OCH | —CH₃ |
| 333 | —CH₂OCH | —C₂H₅ |
| 334 | —CH₂OCH | —OCH₃ |
| 335 | —CH₂OCH | —CH₂OCH |
| 336 | —CH₂OCH | —OCH₂C≡CH |
| 337 | —CH₂OCH | —C(O)OC₄H₉ |
| 338 | —OCH₂C≡CH | H |
| 339 | —OCH₂C≡CH | —CH₃ |
| 340 | —OCH₂C≡CH | —C₂H₅ |
| 341 | —OCH₂C≡CH | —OCH₃ |
| 342 | —OCH₂C≡CH | —CH₂OCH |
| 343 | —OCH₂C≡CH | —OCH₂C≡CH |
| 344 | —OCH₂C≡CH | —C(O)OC₄H₉ |

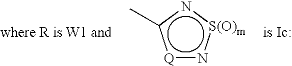

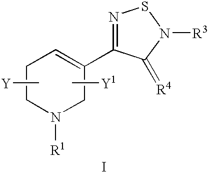

where Y and Y¹ are hydrogen, and m is 0:

| Cmpd. No. | R¹ | R³ | R⁴ | R¹⁰ |
|---|---|---|---|---|
| 345 | H | H | O | — |
| 346 | —CH₃ | H | O | — |
| 347 | —CH₃ | —CH₃ | O | — |
| 348 | —CH₃ | —C₆H₅ | O | — |
| 349 | —CH₃ | —NH₂ | O | — |
| 350 | —CH₃ | —N(CH₃)₂ | O | — |
| 351 | —CH₃ | —N(C₂H₅)₂ | O | — |
| 352 | —CH₃ | —N(CH₃)₂ | O | — |
| 353 | —CH₃ | —OH | O | — |
| 354 | —CH₃ | —OCH₃ | O | — |
| 355 | —CH₃ | —OCH₂C≡CH | O | — |
| 356 | —C₂H₅ | —C₂H₅ | O | — |
| 357 | H | H | S | — |
| 358 | —CH₃ | H | S | — |
| 359 | —CH₃ | —CH₃ | S | — |
| 360 | —CH₃ | —C₆H₅ | S | — |
| 361 | —CH₃ | —NH₂ | S | — |
| 362 | —CH₃ | —N(CH₃)₂ | S | — |
| 363 | —CH₃ | —N(C₂H₅)₂ | S | — |
| 364 | —CH₃ | —N(CH₃)₂ | S | — |
| 365 | —CH₃ | —OH | S | — |
| 366 | —CH₃ | —OCH₃ | S | — |
| 367 | —CH₃ | —OCH₂C≡CH | S | — |
| 368 | —C₂H₅ | —C₂H₅ | S | — |
| 369 | H | H | —NR¹⁰ | H |
| 370 | —CH₃ | H | —NR¹⁰ | CH₃ |
| 371 | —CH₃ | —CH₃ | —NR¹⁰ | CH₃ |
| 372 | —CH₃ | —C₆H₅ | —NR¹⁰ | CH₃ |
| 373 | —CH₃ | —NH₂ | —NR¹⁰ | CH₃ |
| 374 | —CH₃ | —N(CH₃)₂ | —NR¹⁰ | CH₃ |
| 375 | —CH₃ | —N(C₂H₅)₂ | —NR¹⁰ | CH₃ |
| 376 | —CH₃ | —N(CH₃)₂ | —NR¹⁰ | CH₃ |
| 377 | —CH₃ | —OH | —NR¹⁰ | CH₃ |
| 378 | —CH₃ | —OCH₃ | —NR¹⁰ | CH₃ |
| 379 | —CH₃ | —OCH₂C≡CH | —NR¹⁰ | CH₃ |
| 380 | —C₂H₅ | —C₂H₅ | —NR¹⁰ | C₂H₅ |
| 381 | —CH₃ | —CH₃ | —NR¹⁰ | CH₂CH₂C₆H₅ |
| 382 | —CH₃ | —C₆H₅ | —NR¹⁰ | OCH₃ |
| 383 | —CH₃ | —OCH₂C≡CH | —NR¹⁰ | OCH₂CH═CH₂ |
| 384 | —CH₃ | —CH₃ | —NR¹⁰ | NOCH₂C≡CH |
| 385 | —CH₃ | —NH₂ | —NR¹⁰ | OCH₂C≡CCH₃ |
| 386 | —CH₃ | —N(CH₃)₂ | —NR¹⁰ | OCH₂CH₂C≡CH |

¹carboxylic acid salt; ²HCl salt; ³iodide salt; ⁴boron tetrafluoride salt; ⁵bromide salt

The following table sets forth physical characterizing data for certain compounds of formula I of the present invention. The compounds of formula I are identified by numbers that correspond to those in Table 1:

### Characterizing Data

| Compound No. | Empirical Formula | Melting Point/Physical State |
|---|---|---|
| 1 | C₇H₈ClN₃S | OIL |
| 2 | C₁₄H₁₄ClN₃S | SOLID |
| 3 | C₁₀H₁₂ClN₃O₂S | 71-72° C. |
| 4 | C₈H₁₁N₃S | OIL |
| 22 | C₈H₁₀ClN₃S | LIQUID |
| 23 | C₈H₁₀FN₃S | LIGHT BROWN OIL |
| 39 | C₉H₁₃N₃S | LIGHT BROWN OIL |
| 55 | C₁₆H₁₉N₃S | BROWN OIL |
| 56 | C₉H₁₃N₃OS | LIQUID |
| 57 | 2(C₉H₁₄N₃OS)C₂O₄ | TAN SOLID |
| 58 | C₁₁H₁₇N₃OS | OIL |
| 60 | C₁₂H₁₉N₃OS | DARK OIL |
| 62 | C₁₄H₂₃N₃OS | SOLID |
| 63 | C₁₄H₁₄FN₃OS | DARK OIL |
| 64 | C₁₁H₁₅N₃OS | OIL |
| 65 | 2(C₁₁H₁₆N₃OS)C₂O₄ | 132-134° C. |
| 66 | C₁₁H₁₃N₃OS | LIQUID |
| 67 | C₁₂H₁₅N₃OS | OIL |
| 68 | C₁₂H₁₅N₃OS | OIL |
| 71 | C₁₁H₁₇N₃S₂ | OIL |
| 72 | C₁₂H₁₉N₃S₂ | DARK OIL |
| 73 | C₁₃H₂₁N₃S₂ | OIL |
| 74 | C₁₄H₂₀N₄S₂ | DARK OIL |
| 75 | C₁₄H₂₃N₃S₂ | OIL |
| 77 | C₁₁H₁₅N₃S₂ | DARK OIL |
| 79 | C₁₃H₁₉N₃O₂S | OIL |
| 100 | C₉H₁₃N₃S | OIL |
| 102 | C₉H₁₂ClN₃S | OIL |
| 103 | C₉H₁₁Cl₂N₃S | 93-95° C. |
| 104 | (C₉H₁₂Cl₂N₃S)Cl | 93-95° C. |
| 107 | C₁₀H₁₅N₃OS | OIL |
| 108 | C₁₁H₁₇N₃OS | OIL |
| 109 | C₁₂H₁₉N₃OS | OIL |
| 110 | C₁₃H₂₁N₃OS | OIL |
| 111 | C₁₅H₂₅N₃OS | OIL |
| 130 | C₇H₄ClN₃S | SOLID |
| 131 | C₇H₄FN₃S | LIGHT YELLOW OIL |
| 132 | C₈H₇N₃S | 55-57° C. |
| 140 | C₁₀H₁₁N₃OS | OIL |
| 141 | (C₁₁H₁₄N₃OS)I | 123-127° C. |
| 145 | C₁₀H₉N₃OS | 55-57° C. |
| 146 | (C₁₁H₁₂N₃OS)I | 131-134° C. |
| 161 | (C₁₀H₉ClN₃O₂S)BF₄ | 118-120° C. |
| 162 | (C₁₄H₁₁ClN₃S)Br | 47-49° C. |

Candidate pesticides, i.e., insecticides of the present invention were evaluated on 7-10 day old cotton seedlings infested with cotton aphid (Aphis gossypii). At least 12 hours prior to the test, leaf cuttings containing about 50 adult aphids were placed on leaves of each of duplicate cotton seedlings for each rate of application of candidate insecticide. Solutions of the candidate insecticide were prepared for testing by serial dilution of a standard solution comprised of an appropriate amount of insecticide in a water/acetone solvent, which contained a small amount of a surfactant. Rates of application of candidate insecticide may range from about 1000 ppm, or more, to about 3 ppm, or less, in a rate series of, for example, 1000 ppm, 100 ppm, 30 ppm, 10 ppm, and 3 ppm. The solutions containing each rate of application of candidate insecticide were then sprayed to run-off to both the upper and lower portions of the leaves of the aphid-infested cotton seedlings. Each test of foliar-applied candidate insecticide included appropriate standard insecticide of known insecticidal activity and blank treatments to aid in assessing the insecticidal activity of the candidate insecticide. Upon completion of the spraying with candidate insecticide, the cotton seedlings were maintained in a growth chamber for a period of 72 hours. After this time, the seedlings were examined for dead insects. Insects were classified as dead if they were off-color or brown and desiccated. Upon completion of the evaluation of the test, the percent mortality of the cotton aphid for each rate of application of the candidate insecticide was determined by comparison of the total number of dead insects to the total number of insects in the test. Table 3 sets forth the insecticidal activity of the compounds tested in this test.

TABLE 3
Insecticidal Activity of 1,2,5-Thiadiazoles
Foliar Tests against Cotton Aphids

| Compound No. | Rate of Appln. (ppm) | Percent Mortality^{1,2} |
|---|---|---|
| 2 | 1000 | LP |
| 3 | 1000 | LP |
| 4 | 1000 | 86 |
| | 300 | 73 |
| | 100 | 24 |
| 23 | 1000³ | 11 |
| 57 | 1000³ | 19 |
| 60 | 1000 | LP |
| 63 | 1000³ | 48 |
| 68 | 1000 | LP |
| 71 | 1000³ | 23 |
| 73 | 1000 | LP |
| 75 | 1000 | 25 |
| 100 | 300 | 90 |
| 102 | 1000 | 33 |
| | 300 | 8 |
| 107 | 1000 | 24 |
| | 300 | 12 |
| 108 | 1000 | 17 |
| | 300 | 3 |
| 109 | 1000 | 67 |
| | 300 | 17 |
| 110 | 1000 | LP |
| 111 | 1000 | 25 |
| | 300 | 7 |
| 132 | 1000 | 82 |
| | 300 | 35 |
| 140 | 1000 | LP |

¹Percent mortality is derived from the number of dead insects (TD) relative to the total number of insects (TI) used in the test, % Mortality = TD/TI × 100
²LP means that some activity was observed because the population of the cotton aphids was lowered but a value was not calculated.
³Average of two tests.

Compounds of the present invention provided insecticidal activity in the foliar test against the cotton aphid. Four of the compounds set forth in Table 3 provided insect mortality of greater than 65% (Compounds 4, 100, 109 and 132), of which three of the compounds provided insect mortality of greater than 80% (Compounds 4, 100 and 132).

Candidate pesticides, i.e., acaricides of the present invention were evaluated on 7-8 day old pinto bean seedlings infested with two-spotted spider mite (Tetranychus urticae) in comparison with the corresponding 1,2,4-thiadiazole derivatives. The test was conducted using the test method set forth below:

One to two hours prior to the test, leaf cuttings containing about 50-75 adult mites were placed on leaves of each of duplicate pinto bean seedlings for each rate of application of candidate acaricide. Solutions of the candidate acaricide were prepared for testing by serial dilution of a standard solution comprised of an appropriate amount of acaricide in a water/acetone solvent, which contained a small amount of a surfactant. Rates of application of candidate acaricide may range from about 1000 ppm, or more, to about 1 ppm, or less, in a rate series of, for example, 1000 ppm, 300 ppm, 100 ppm, 30 ppm, 10 ppm, 3 ppm, and 1 ppm. The solutions containing each rate of application of candidate acaricide were then sprayed to run-off to both the upper and lower portions of the leaves of the mite-infested pinto bean seedlings. Each test of foliar-applied candidate acaricide included appropriate standard acaricide of known acaricidal activity and blank treatments to aid in assessing the acaricidal activity of the candidate acaricide. Upon completion of the spraying with candidate acaricide, the pinto bean seedlings were maintained in a growth chamber for a period of 72 hours. After this time, the seedlings were examined for dead acarids. Acarids were classified as dead if they failed to show movement when probed. Upon completion of the evaluation of the test, the percent control of the two-spotted spider mite for each rate of application of the candidate acaricide was determined by comparison of the total number of dead and motibund acarids to the total number of acarids in the test. Table 4 sets forth the acaricidal activity of the compounds tested in this test.

TABLE 4
Acaricidal Activity of 1,2,5-Thiadiazoles in Foliar Tests against Two-Spotted Spider
Mites; A Comparison With Corresponding 1,2,4-Thiadiazoles

| Compound Number | Rate of Application (ppm) | Percent Control |
|---|---|---|
| 4 | 1000 | 100 |
| | 300 | 100 |
| | 100 | 100 |
| | 30 | 96 |
| | 10 | 49 |
| 23 | 300 | 100 |
| | 100 | 98 |
| | 30 | 95 |
| | 10 | 35 |
| 57 | 1000 | 53 |
| | 300 | 34 |
| 58 | 1000 | 56 |
| | 300 | 27 |
| 60 | 1000 | 41 |
| | 300 | 10 |
| 66 | 1000 | 98 |
| | 300 | 83 |
| | 100 | 52 |
| 67 | 1000 | 100 |
| | 300 | 100 |
| 71 | 1000 | 69 |
| | 300 | 20 |
| 72 | 1000 | 34 |
| | 300 | 4 |
| 77 | 1000 | 92 |
| | 300 | 13 |
| 102 | 1000 | 77 |
| | 300 | 27 |
| | 100 | 13 |
| 109 | 1000 | 65 |
| | 300 | 15 |
| 110 | 1000 | 87 |
| | 300 | 34 |
| A | 300 | Inactive |
| B | 300 | Inactive |
| 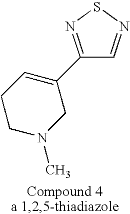 | 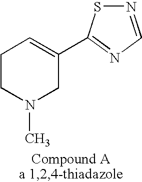 | 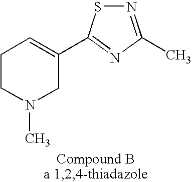 |

¹Percent mortality is derived from the number of dead acarids (TD) plus the number of moribund acarids (TM) relative to the number of acarids (TI) used in the test, % Control = (TD + TM)/TI × 100

Compounds of the present invention showed unexpectedly improved activity in the foliar test against the two-spotted spider mite when compared to the corresponding 1,2,4-thiadiazole derivatives. At a low application rate of 300 ppm, compounds 4, 23, 66 and 67 all provided better than 80% control of two-spotted spider mite, with compounds 4, 23, and 67 providing 100% control. In contrast, compounds A and B, the 1,2,4-thiadiazole derivatives, were completely inactive at the application rate of 300 ppm. At the higher rate of application of 1000 ppm, compounds 57, 58, 60, 71, 72, 77, 102, 109 and 110 provided control of two-spotted spider mite varying from 34% to 92%.

While the invention has been described in detail and with reference to specific embodiments thereof, it will be apparent to one skilled in the art that various changes and modifications can be made therein without departing from the spirit and scope of the invention as defined by the following claims.

What is claimed is:

1. A pesticidal composition comprising a pesticidally effective amount of a compound of formula I in admixture with at least one agriculturally acceptable extender or adjuvant, wherein said compound of formula I is: 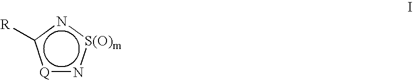
wherein
—R is an azacycle selected from: 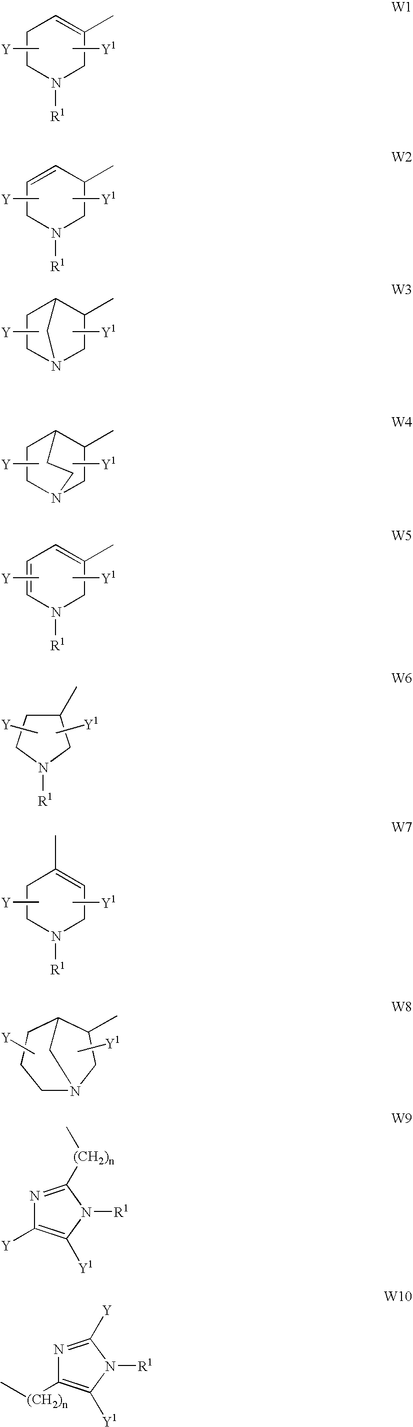 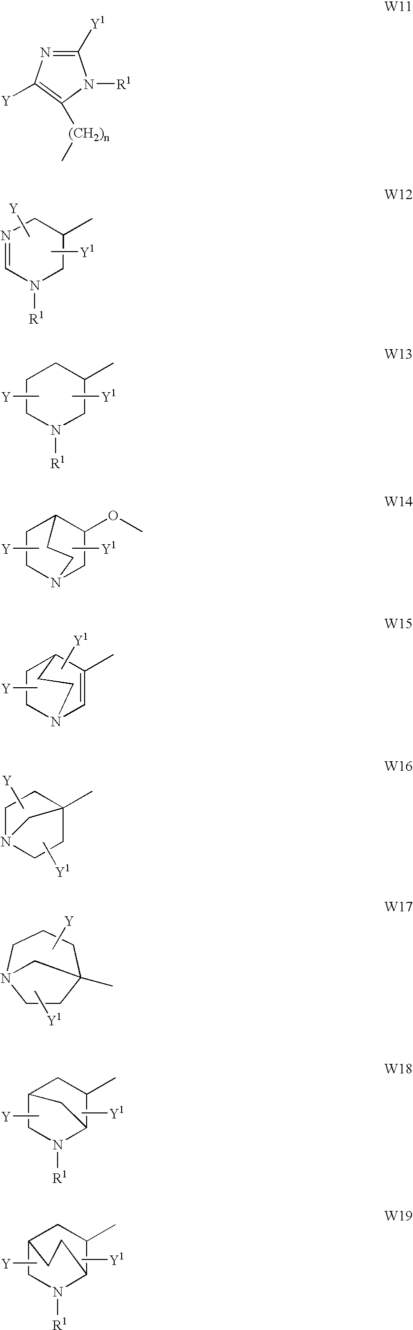 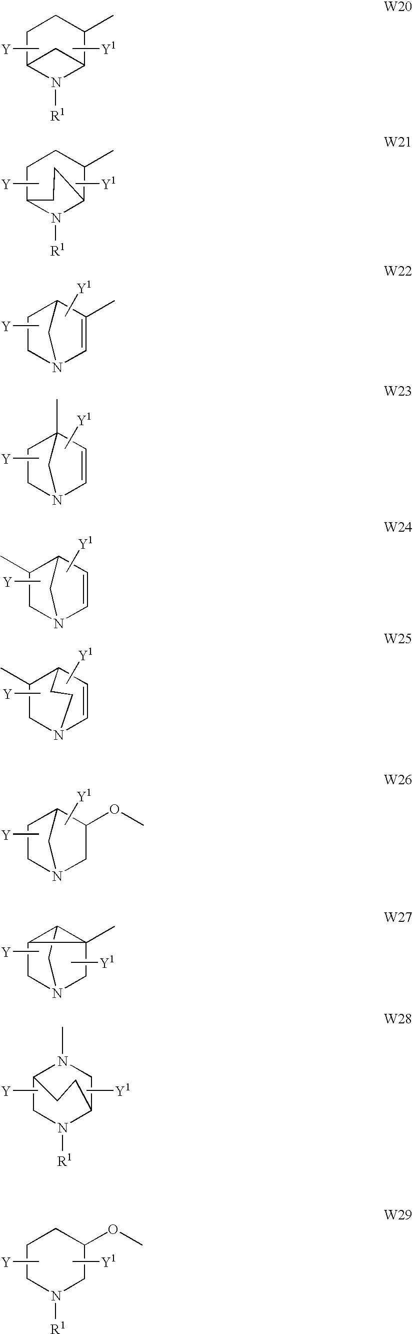
where
—Y and Y¹ may be attached at the same or different positions, and are independently selected from hydrogen, halogen, cyano, nitro, amino, carboxyl, alkyl, haloalkyl, alkenyl, alkoxy, haloalkoxy, aminoalkoxy, alkylcarbonyl, haloalkylcarbonyl, alkoxycarbonyl, haloalkoxycarbonyl, arylalkyl, aryl, aryloxy, and heterocyclyl, where the aryl and heterocyclyl moieties may be optionally substituted with halogen, alkyl, haloalkyl, alkoxy, or haloalkoxy;
n is an integer from 0 to 2;
R¹ is selected from hydrogen, alkyl, haloalkyl, alkenyl, haloalkenyl, alkenyloxy, alkynyl, alkynyloxy, alkoxy, alkoxyalkyl, haloalkoxy, alkylcarbonyl, alkyloxycarbonyl, alkoxycarbonylalkoxy, arylcarbonyl, aryloxycarbonyl, haloalkoxycarbonyl, carboxyl and arylalkyl; wherein the aryl may be optionally substituted with halogen, alkyl, haloalkyl, alkoxy, or haloalkoxy;
and wherein 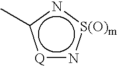
is a 1,2,5-thiadiazole where Q is CR² or C═R⁴, wherein said 1,2,5-thiadiazole is selected from 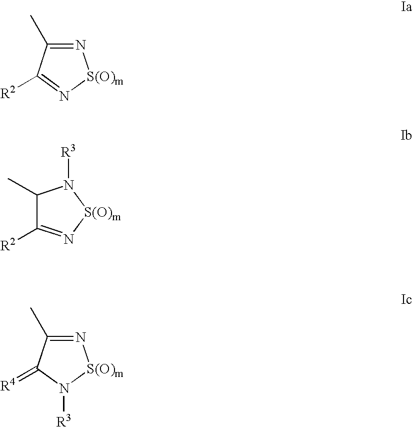
a 1,2,5-thiadiazol-3-yl a 1,2,5-thiadiazolin-3-yl a 1,2,5-thiadiazolin-3-R⁴-4-yl 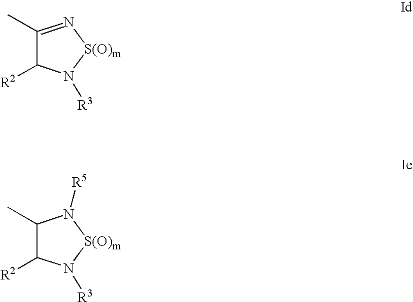
a 1,2,5-thiadiazolin-4-yl a 1,2,5-thiadiazolidin-3-yl
where
m is an integer from 0 to 2;
—R² is selected from hydrogen, hydroxy, halogen, amino, nitro, alkyl, haloalkyl, alkenyl, haloalkenyl, alkynyl, haloalkynyl, alkylaryl, alkoxy, haloalkoxy, aryloxy, alkenyloxy, haloalkenyloxy, alkynyloxy; thiol, alkylthio, haloalkylthio, cyanoalkylthio, arylthio, alkenylthio, alkynylthio, alkyloxycarbonyl, carboxyl; —N(R⁶)(R⁷); —NHN(R⁶)(R⁷); —NHC(O)R⁶; —NHC(O)OR⁶; —OC(O)R⁶; where the aryl may be optionally substituted with halogen, alkyl, haloalkyl, alkoxy, cyano, or haloalkoxy moiety;
where
R⁶ and R⁷ are independently selected from hydrogen, alkyl, arylalkyl, alkoxy, acetyl, alkoxycarbonyl, alkoxyalkyl, aminoalkyl, and carbonylamino;
—R³ and R⁵ are independently selected from hydrogen, hydroxy, alkyl, alkoxy, alkoxyalkyl, aryl, arylalkyl, —N(R⁸)(R⁹); —NHC(O)R⁸ and —NHC(O)OR⁸; where the aryl may be optionally substituted with halogen, alkyl, haloalkyl, alkoxy, cyano, or haloalkoxy moiety;
where
R⁸ and R⁹ are independently selected from hydrogen, alkyl, arylalkyl, alkoxy, acetyl, alkoxycarbonyl, alkoxyalkyl, aminoalkyl, and aminocarbonyl; or are taken together with R¹ to form a hetero-atom link;
—R⁴ is selected from O, S and NR¹⁰;
where
R¹⁰ is selected from hydrogen, alkyl, alkoxy, alkoxyalkyl, alkenyl, alkynyl, alkenyloxy, alkynyloxy, aryl and arylalkyl;
and
the corresponding agriculturally acceptable salts thereof.

2. The composition of claim 1, wherein said azacycle R is selected from W1, W3, W4, W8; W10 and W11, where n is 1 or 2; W13, W14, W15, W20, W26, W28 and W29;
where
—Y and Y¹ are independently selected from hydrogen and halogen;
—R¹ is selected from hydrogen, alkyl, haloalkyl, alkoxyalkyl, arylalkyl, alkenyl, haloalkenyl, alkynyl, alkylcarbonyl and alkoxycarbonyl;
and,
said 1,2,5-thiadiazole is selected from i) ia, where m is 0, and ii) lb and Id, where m is 0 or 2;
where
—R² is selected from hydrogen, halogen, alkoxy, alkenyloxy, alkynyloxy, alkylthio, alkenylthio, and alkynylthio;
and
—R³ is selected from hydrogen, hydroxy, alkyl, alkoxyalkyl, aryl and N(R⁸)(R⁹);
where
R⁸ and R⁹ are independently selected from hydrogen, alkyl, alkoxy and alkoxyalkyl.

3. The composition of claim 2, wherein said azacycle R is selected from W1, W3, W4, W13, W14 and W26, where Y and Y¹ are hydrogen and R¹ is selected from hydrogen, alkyl, haloalkyl, alkoxyalkyl, alkylcarbonyl, alkoxycarbonyl and arylalkyl; and said 1,2,5-thiadiazole is selected from i) Ia, where m 0.

4. The composition of claim 3, wherein said azacycle R is selected from W1, W3 and W4; R¹ is selected from alkyl, haloalkyl, alkoxyalkyl and arylalkyl; and R² is selected from hydrogen, halogen, alkoxy, alkynyloxy and alkynylthio.

5. A pesticidal composition comprising a pesticidally effective amount of a compound of formula I in admixture with at least one agriculturally acceptable extender or adjuvant, wherein said compound of formula I is: 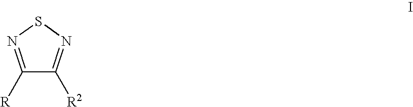
where R is an azacycle selected from: 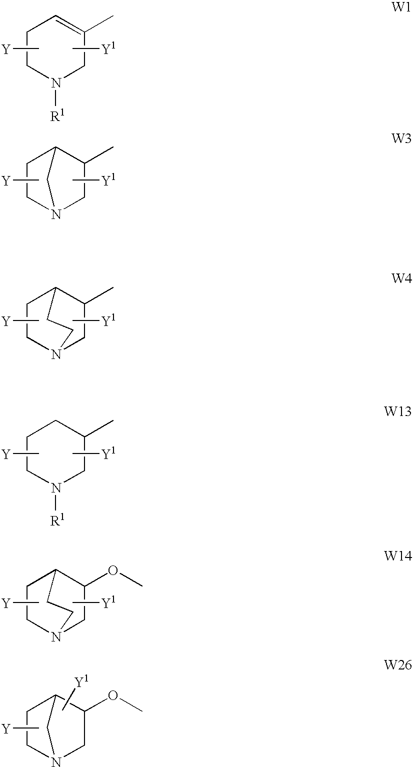
where
—Y and Y¹ are hydrogen;
R¹ is selected from hydrogen, alkyl, haloalkyl, alkoxyalkyl, alkylcarbonyl, alkoxycarbonyl and arylalkyl;
and
—R² is selected from hydrogen, halogen, alkoxy, alkenyloxy, alkynyloxy, alkylthio, alkenylthio, and alkynylthio.

6. The composition of claim 5, wherein said azacycle R is selected from W1, W3 and W4; R¹ is selected from hydrogen, alkyl, haloalkyl, alkoxyalkyl and arylalkyl; and R² is selected from hydrogen, halogen, alkoxy, alkynyloxy and alkynylthio.

7. The composition of claim 6, wherein R¹ is selected from hydrogen and alkyl, and R² is selected from hydrogen, chlorine, fluorine, alkoxy and alkynyloxy.

8. The composition of claim 1, further comprising one or more second compounds selected from the group consisting of pesticides, plant growth regulators, fertilizers and soil conditioners.

9. A method of controlling insects and acarids, comprising applying an insecticidally and acaricidally effective amount of a composition of claim 1 to a locus where insects and acarids are present or are expected to be present.

10. A method of controlling insects and acarids, comprising applying an insecticidally and acaricidally effective amount of a composition of claim 8 to a locus where insects and acarids are present or are expected to be present.
